(19) United States
(12) Patent Application Publication
(10) Pub. No.: US 2004/0206710 A1
(43) Pub. Date: Oct. 21, 2004

(54) Filtration apparatus and filtration method

(76) Inventors: Yosuke Yamada, Chiba (JP); Kenichiro Yamada, Chiba (JP); Hoko Terasawa, Saitama (JP)

Correspondence Address: FISH & RICHARDSON P.C., 45 ROCKEFELLER PLAZA, SUITE 2800, NEW YORK, NY, 10111, US

(21) Appl. No.: 10/757,218

(22) Filed: Jan. 14, 2004

(30) Foreign Application Priority Data
Jan. 16, 2003 (JP) P.2003-007836
Apr. 11, 2003 (JP) P.2003-107779
Mar. 4, 2003 (JP) P.2003-056618

(51) Int. Cl. B01D 24/46

(52) U.S. Cl. 210/792; 210/269

(57) ABSTRACT

A spiral flow is generated in an outermost surface of a filter layer 103a formed of floating filter media 103 housed inside a filtration tube 102. This spiral flow can carry out filtration of the wastewater while scraping off floating filter media 103 forming the outermost surface of the filter layer 103a. This spiral flow can also be generated by discharging the wastewater inside the filtration tube in a direction following an inner wall thereof. Moreover, the tornado flow can also be generated by sucking this spiral flow downward to obtain an even more effective prevention of the clogging of the filter layer 103a.

### FIELD OF THE INVENTION

The present invention relates to a filtration device (apparatus) using floating filter media and more particularly to a device (apparatus) which handles efficient and reliable filtration of industrial waste, etc. while enabling prolonged preservation of excellent filtration characteristics by successively removing, during the filtration process, the dirt adhered to the filter media.

### DESCRIPTION OF THE BACKGROUND ART

Wastewater is generated in large quantities in plants and on worksites and it is directly discharged to the outside thus causing environmental pollution. Therefore, a need was felt to remove contaminants (solid components) contained in the wastewater before discharge to the exterior. Examples of wastewater are as follows:

alkaline degreasing liquids,

emulsifying waste generated in industrial plants,

water-soluble grinding liquid,

aqueous solutions used when buffing steel plates, copper plates or stainless plates (aqueous solution contains steel particles, copper particles or stainless particles)

cement-laden water and mud-laden water generated in traffic work zones or on construction sites,

paint washing wastewater containing paint.

Conventionally, such wastewater used to be filtered by use of a filter and metal particles used to be removed by attraction by means of a magnet.

Since, as described hereinabove, the wastewater contains a large quantity of contaminants, when filtration is carried out by means of a filter, etc, the filter clogs very rapidly. The operation to replace the clogged filter, etc. is complicated and the used filter, etc. that has been replaced becomes a new refuse which is disposed of directly and therefore a problem existed that a new polluting agent is generated. The operation of attracting the metal particles by use of a magnet was ineffective and it could not remove other contaminants besides the metal particles.

In view of the abovementioned background art, the present invention provides a filtration device (apparatus) and a filtration method for successively removing contaminants (solid components) contained in the wastewater and adhered to the bottom surface of the filter layer (stratified filter media) and for preserving excellent filtration characteristics for a long period of time.

### SUMMARY OF THE INVENTION

A filtration device (apparatus) of the present invention comprises a filtration container for housing floating filter media forming a stratified filter layer; a supply pipe for supplying a treatment liquid containing removables to the filtration container; a discharge pipe for evacuating the treatment liquid which was subject to filtration, wherein by generating a spiral flow in a lower side of the filter layer, a downward force which is stronger than a buoyant force exerted in the floating filter media is applied to the floating filter media constituting a bottom layer of the filter layer to separate the floating filter media constituting the bottom layer from the filter layer.

Further, with the present invention, in the filtration method according to which a treatment liquid comprising removables is passed through a filter layer formed of a floating filter medium to carry out filtration of the treatment liquid, a downward force which is stronger than the buoyant force exerted in the floating filter media is applied to the floating filter media of a bottom layer of the filter layer to separate the floating filter media of the bottom layer from the filter layer by generating a spiral flow in the bottom side of the filter layer.

Moreover, with the present invention, in the filtration method according to which a treatment liquid comprising removables is passed through a filter layer formed of an aggregation of floating filter media to carry out filtration of the treatment liquid, washing of the floating filtration media is carried out by generating, inside the filtration container housing the floating filter media, a spiral flow formed of the treatment liquid enveloping the floating filtration media.

### BRIEF DESCRIPTION OF THE DRAWINGS

FIG. 1 is a block diagram showing a filtration device according to a first embodiment of the invention.

FIG. 2A is a cross-sectional view and FIG. 2B is another cross-sectional view showing a supply pipe coupled to the filtration tube.

FIG. 3 is a development elevation showing a drainage structure.

FIG. 4 is a perspective view illustrating a separation member.

FIG. 5 is a block diagram showing a filtration device using oblique plates as a separation member.

FIG. 6 is a block diagram showing a filtration device using a funnel-shaped member as a separation member.

FIG. 7 is a block diagram showing a filtration device according to a second embodiment of the invention.

FIG. 8 is a block diagram showing a filtration device according to a third embodiment of the invention.

FIG. 9 is a block diagram showing a filtration device according to a fourth embodiment of the invention.

FIG. 10 is a block diagram showing a filtration device according to a fifth embodiment of the invention.

FIG. 11 is a block diagram showing a filtration device according to a sixth embodiment of the invention.

FIG. 12 is a block diagram showing a filtration device according to a seventh embodiment of the invention.

FIG. 13 is a block diagram showing a filtration device according to an eighth embodiment of the invention.

FIG. 14 is a block diagram showing a filtration device according to a ninth embodiment of the invention.

FIG. 15 is a cross-sectional view showing a cross-section taken along the line III-III of FIG. 14.

FIG. 16 is a block diagram showing a filtration device according to a tenth embodiment of the invention.

FIG. 17 is a block diagram showing a filtration device according to an eleventh embodiment of the invention.

FIG. 18 is a block diagram showing a filtration device according to a twelfth embodiment of the invention.

FIG. 19 is a block diagram showing a filtration device according to a thirteenth embodiment of the invention.

FIG. 20 is a block diagram showing a filtration device according to a fourteenth embodiment of the invention.

FIG. 21 is a block diagram showing a filtration device according to a fifteenth embodiment of the invention.

FIG. 22 is a perspective view showing a separation member.

FIG. 23 is a block diagram showing a filtration device according to a fifteenth embodiment of the invention.

### DETAILED DESCRIPTION OF THE INVENTION

Next, embodiments of the present invention will be described with reference to the figures.

First Embodiment

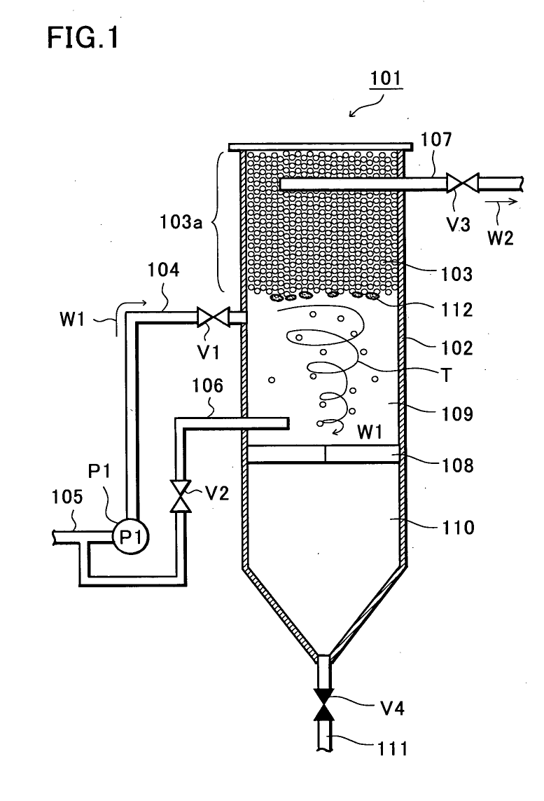

FIG. 1 refers to a first embodiment of the present invention and shows a filtration device (apparatus) 101 having floating filter media. FIG. 1 shows the filtration device 101 which is being supplied with treatment wastewater such as wastewater etc. Some examples of treatment wastewater can be water containing metal particles, paint ingredients, plastic, or dirt. Chemicals containing fine powder of plating residue, etc. also belong to the category of treatment wastewater of the present invention. A filtration tube 102 of the filtration device 101 has a cylindrical shape and upon operation, it is positioned (fixed, installed) so that the axis thereof follows a vertical direction and an upper surface and a lower surface thereof are obstructed.

A plurality of granular floating filter media 103 are provided inside the filtration tube 102 which is a filtration container. As filter media 103, material having a specific gravity lower than that of the treatment liquid to be treated is used, like for instance, in the case of wastewater having water as the primary component, very fine foam polystyrene particles, resin particles or inorganic material particles having a specific gravity smaller than 1 are employed. Consequently, when treatment wastewater W1 is fed into the filtration tube 102, the filter media 103 float and discrete filter media 103 are tightly pressed by hydraulic pressure and buoyant force of the filter media to form a dense structure. Due to this fact, a filter layer 103a is formed by the floating filter media 103 and micro-filtration is enabled. Particles of the filter media 103 have special dimensions within the range of, for example 0.05 mm˜3 mm (diameter), and filter media 103 with optimal particle size formed of suitable material according to the wastewater type are employed.

Teflon, nylon, foam polystyrene, etc. can be employed for the filter media which are selected according to the composition of the treatment wastewater. If the treatment wastewater is corrosive, teflon and nylon can be employed as filter media. Alternatively, when the treatment wastewater is not corrosive, foam polystyrene can be employed as filter medium. Further, the particle size (diameter) of the filter media is selected according to the size of the removables. Here, when the particle size of the removables is extremely small, filter media having a particle size of smaller than 0.05 mm can also be used. It is also possible to employ removables-laden oil as treatment wastewater.

In the portion (bottom portion) where the filter media 103 float and the filter layer 103 is not formed, a supply pipe 104 provided with a valve V1 is coupled to the filtration tube 102. A pump P1 aspirates treatment wastewater W1 from a wastewater containment tank, etc. via a treatment wastewater pipe 105 and supplies it to the supply pipe 104. Therefore, the treatment wastewater W1 discharged from the pump P1 is pumped inside a bottom space (space where the filter layer 104a is not formed) in the interior of the filtration tube 102 via the supply pipe 104.

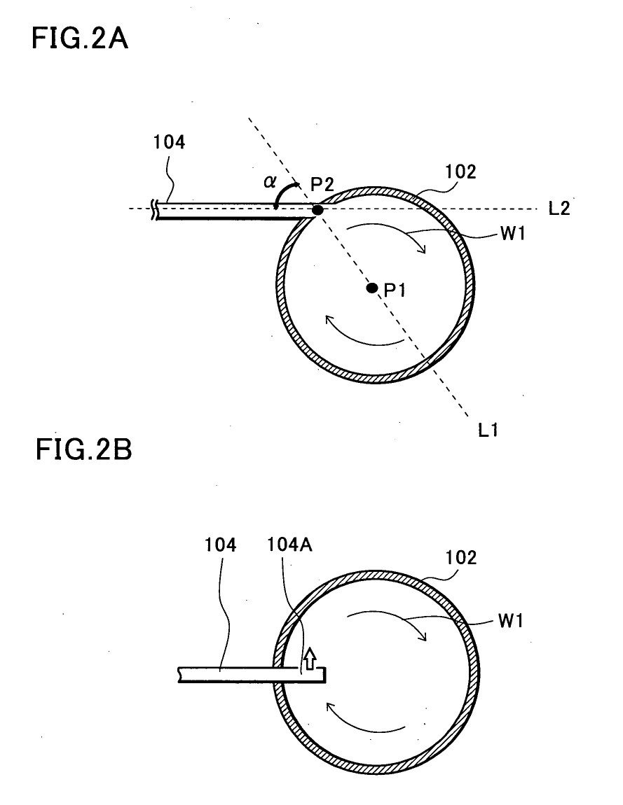

As shown in the cross-sectional view of FIG. 2A, the supply pipe 104 functioning as a supply means is positioned obliquely relative to the radial direction of the filtration tube 102. Treatment wastewater W1 fed from the supply pipe 104 to the filtration tube 102 is pumped in along the inner wall of the filtration tube 102, and inside the filtration tube 102, the treatment wastewater W1 rotates/circles round along the inner wall of the filtration tube 102. Concretely, the supply pipe 104 is connected tangentially relative to the radial direction of the filtration tube 102.

Next, with reference to FIG. 2A, a concrete description will be given to the cross-section coupling structure between the filtration tube 102 and the supply pipe 104. First, assume that P1 is the central point in the cross-section of the circular filtration tube 102 and P2 is the contact location between the supply pipe 104 and the filtration tube 102. Then, assume that L1 is a line connecting P1 and P2, and L2 is the extending direction of the axis of the supply pipe 104. In the present embodiment, the supply pipe 104 is coupled to the filtration tube 102 so that L1 and L2 intersect. Assuming that the angle where L1 and L2 intersect is α, the larger the angle α, the bigger the action that generates the spiral flow. In other words, the extending direction of the supply pipe 104 is oriented in a direction other than towards the center P1 of the filtration tube 102. Alternatively, the cross section of the filtration tube 102 may take other shapes than circular.

Referring to FIG. 2B, other possible cross-sectional structures will be described. Here, supply pipe 104 extends towards the central part of the filtration tube 102. Then, in the proximity of the tip of the supply pipe 104, an exhaust nozzle 104A is provided for pumping the treatment liquid inside the filtration tube 102. Here, the exhaust nozzle 104A is so positioned that the treatment liquid can be pumped in along an inner wall of the filtration tube 102. Alternatively, the supply pipe 104 can also extend in directions other than the central part of the filtration tube 102.

In FIG. 1 and FIG. 2, the treatment wastewater W1 is supplied by means of one supply pipe 104, however, a plurality of supply pipes positioned obliquely relative to the radius of the filtration tube 102 may be arranged spaced away in a circumferential direction of the filtration tube 102. Of course, in such a case, in order to synchronize rotation/whirling directions of the treatment wastewater W1 pumped in from the plurality of supply pipes, orientations of the supply pipes are brought in line with each other.

A suction pipe 106 functioning as a suction means provided with a valve V2, is coupled to the filtration tube 102 at a position lower than the position where the supply pipe 104 is coupled to filtration tube 102. In the present embodiment, the suction pipe 106 penetrates the filtration tube 102 and a tip thereof extends until the center of the internal space of filtration tube 102, however, it is not necessary that it always extend until the center of the internal space of filtration tube 102. The rear tip of the suction pipe 106 is coupled to the treatment wastewater pipe 105. Because of this, when pump P1 is operated, a part of the treatment wastewater W1 fed to the internal space of filtration tube 102 is aspirated downwards and is evacuated to the exterior through suction pipe 106. In order to prevent aspiration of the filter media 103 by the pump P1, a mesh member which does not allow permeation of filter media 103 but allows permeation of the treatment wastewater W1 can be attached at the tip opening of the suction pipe 106. The spiral flow described above can also be generated without using the abovementioned pump. The spiral flow can be generated by the hydraulic pressure generated by positioning the wastewater containment tank at a high altitude.

A treated water pipe 107 provided with a valve V3 is inserted in the filtration tube 102 at a portion (upper portion) where the filter media 103 float to form the filter layer 103a is formed. The tip portion of the treated water pipe 107 which is inserted inside the filtration tube 102 has a drainage structure that allows permeation of the treatment liquid but does not allow permeation of the filter media 103. The treated water pipe 107 functions as a discharge means.

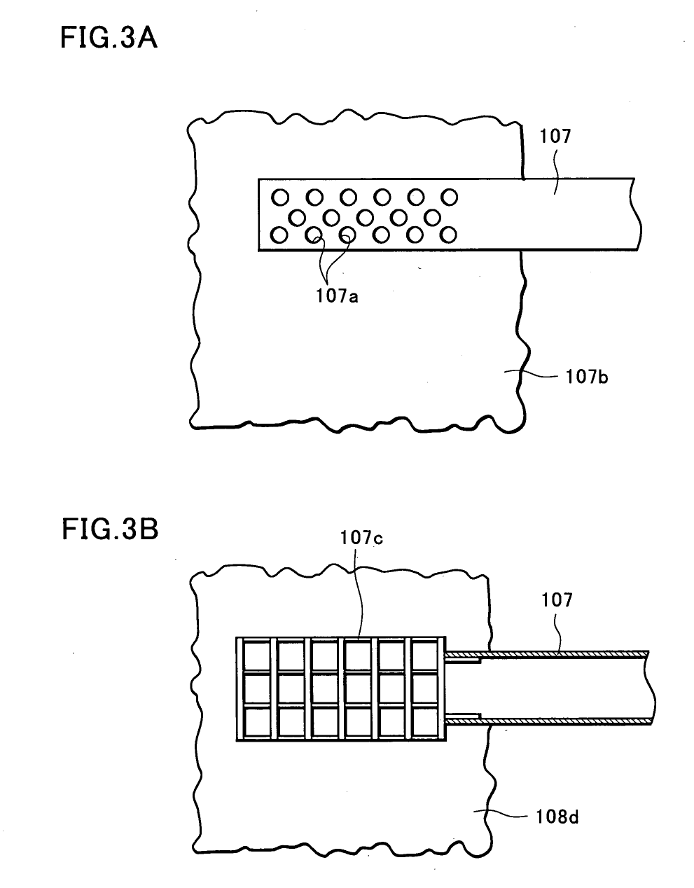

In other words, a plurality of holes 107 are opened in the tip portion of the treated water pipe 107 as disclosed by FIG. 3(a), for instance, and the portions where holes 107 are formed have a drainage structure wrapped in a liquid-permeable film 107b (for instance, cloth) that allows permeation of the treatment liquid but does not allow permeation of the filter media 103. Alternatively, as described in FIG. 3(b), a mesh tube 107c is coupled to the tip of the treated water pipe 107, and the tip portion of the treated water pipe 107 and the mesh tube 107c have a drainage structure wrapped in a liquid-permeable film 107d (for instance, cloth) that allows permeation of the treatment liquid but does not allow permeation of the filter media 103. As for the drainage structure, any possible structure which enables permeation of the liquid but prohibits permeation of the filter media 103 can be employed. Accordingly, a treated water evacuation structure is constituted by the treated water pipe 107 designed in the drainage structure.

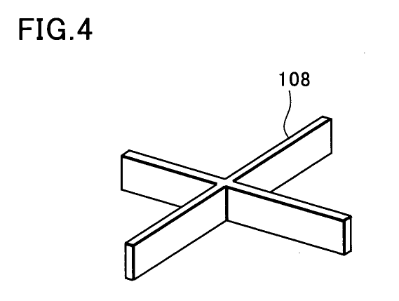

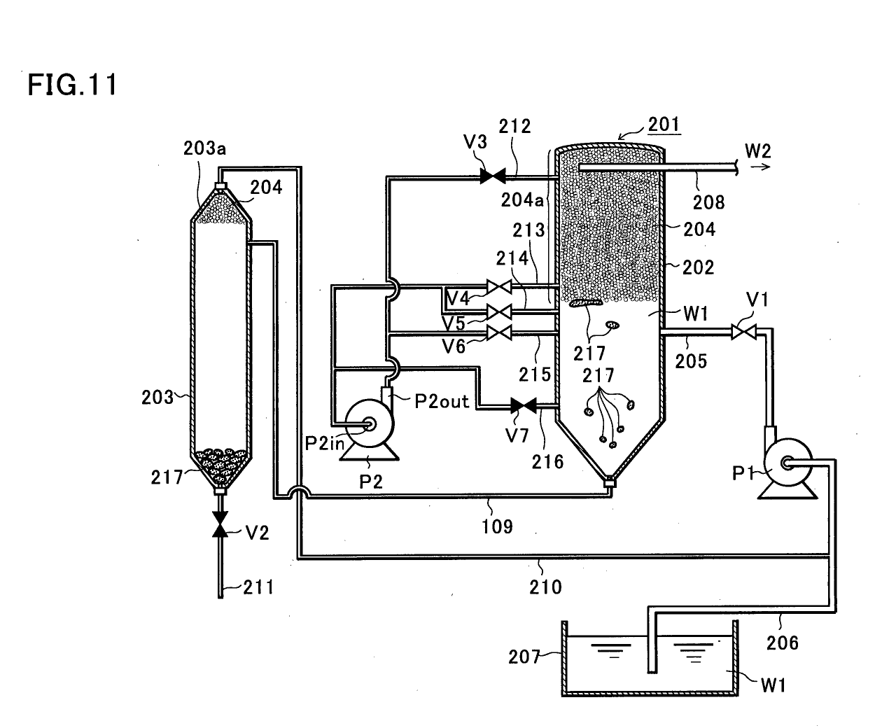

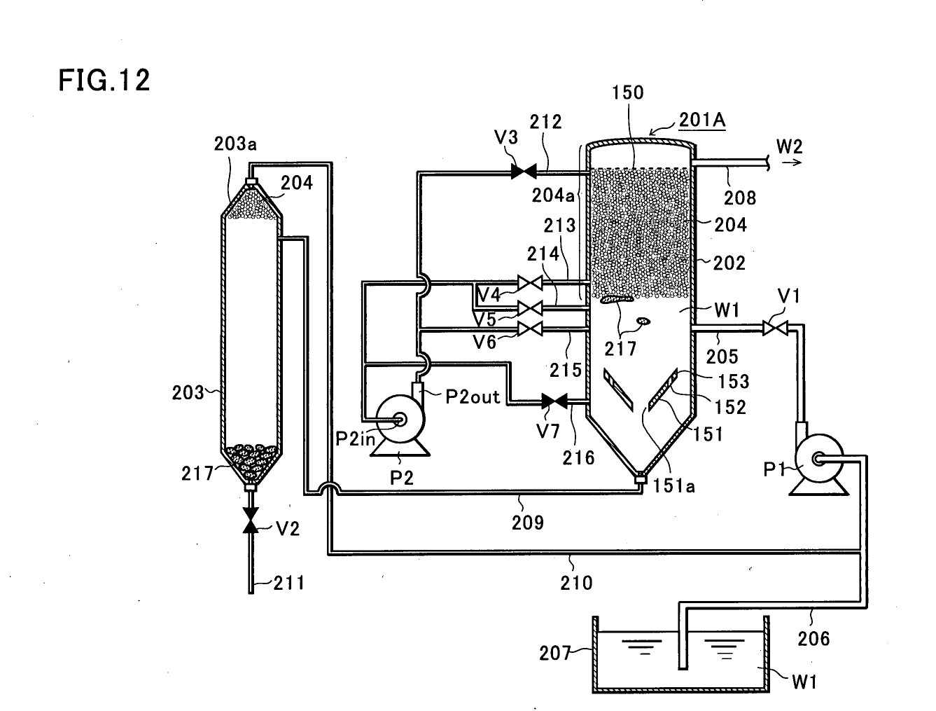

A separation member 108 is fixedly positioned inside the filtration tube 102. In the present embodiment, the separation member 108 is located at a lower position than the coupling position of the supply pipe 104 and the suction pipe 106 with the filtration tube 102. That is, the separation member 108 is located at the lower extremity of the spiral flow or, below that lower extremity. The separation member 108 separates the interior of the filtration tube 102 into a filtration chamber 109 at the upper side and a collector 110 at the lower side. As illustrated in FIG. 4, the separation member 108 comprises two intersecting plates which create a cross-like shape to thereby maintain a communication condition between the filtration chamber 109 and the collector 110. However, since the separation member 108 is thick in a vertical direction, the tornado flow T of the treatment wastewater W1 to be described later crashes into the separation member 108 and the treatment wastewater W1 settles down to substantially a state of rest inside the collector 110 with substantially no tornado flux T being transmitted to the collector. The separation member can also be employed with the devices shown in FIG. 11 and FIG. 12.

A drainage pipe 111 provided with a valve V4 is connected to the bottom of the filtration tube 102.

Next, operation of the filtration device 101 having the structure hereinabove will be described.

When filtration is carried out, valves V1, V2, V3 are opened and valve V4 is closed and pump P1 is driven. Then, the treatment wastewater W1 is fed inside the filtration tube 102 via the treatment wastewater pipe 105, the pump P1 and the supply pipe 104 to fill up the inside of the filtration tube 102 therewith.

When the treatment wastewater W1 has been supplied to the filtration tube 102 as described, the floating filter media 103 having a small specific gravity float such that discrete filter media 103 are tightly pressed to form a dense structure. Due to this, an extremely robust filter layer 103a is formed by the filter media 103 and, depending on the size of the filter media, micro-filtration is enabled.

A part of the treatment wastewater W1 is filtered by distributing the treatment wastewater W1 upwardly in the interval among the filter media 103 forming the filter layer 103a. The filtered treated water W2 is discharged via treated water pipe 107. The treated water W2 is clear as contaminants have been filtered/removed and it can be discharged into the external environment without any risk of causing environmental damage. The treated water W2 can also be reused in plants, etc. as industrial water. When the treatment liquid is acidic or alkaline, etc., a chemical neutralization process is carried out as needed before discharge into the environment.

Contaminants 112 (solid components) contained in the treatment wastewater W1 are separated through filtration, gravitate to the bottom of filtration chamber 109 (in a space at a lower position than the filter layer 103a of the filtration chamber 109), pass the separation member 108 and move downward until they fall into the collector 110.

The treatment wastewater W1 fed from the supply pipe 104 to the filtration tube 102 is pumped in along the inner wall of the filtration tube 102 and, inside the filtration tube 102, the treatment wastewater W1 rotates/whirls in a direction following the inner wall of the filtration tube 102. In other words, the treatment wastewater W1 rotates/whirls inside the filtration chamber 109 (in a space at a lower position than the filter layer 103a of the filtration chamber 109) to generate the spiral flux.

Simultaneously, a part of the treatment wastewater W1 supplied to the filtration chamber 109 returns to pump P1 via the suction pipe 106 after being aspirated downward. That is, the treatment wastewater W1 flows downward inside the filtration chamber 109 (in a space at a lower position than the filter layer 103a of the filtration chamber 109). Generally, a tornado has an effect of moving things above the ground upward, however, here, on the contrary, it has an action of moving the upper removables downward.

Finally, by combining the rotating/whirling flow and the downward flow inside the filtration chamber 109, the treatment wastewater W1 is induced a tornado flow T (refer to FIG. 1) that whirls downward like a tornado. In other words, the flow rotating/whirling parallel to the bottom surface of the filter layer 103a is a spiral flow which is caused to have a downward motion by pulling down the spiral flow using some techniques. In the present embodiment, a suction power via the suction pipe 106 generates a whirling spiral flow moving downwards. In the present embodiment, this flow is called a tornado flow.

With the treatment liquid flow described hereinabove, a downward force which is stronger than the buoyant force operating in the floating filter media 103 operates in the floating filter media of the bottom layer of the filter layer 103a. Accordingly, the floating filter media 103 positioned in the bottom layer of the filter layer 103a are scraped off from the filter layer and are caught up in the flow.

In this manner, a tornado flow T of the treatment wastewater W1 is generated inside the filtration chamber 109. Due to this, a part of the filter media 103 in the bottom surface of the filter layer 103a are scaled off/scraped off by the tornado flow T and with this, contaminants 112 which have temporarily adhered to the bottom surface of the filter layer are scaled off. As a result, the gradual forming of new surfaces free of contaminants 112 adherence renders clogging in the bottom surface of the filter layer 103a formed of filter media 103 unlikely to occur. It is therefore possible to carry out filtration process for a long period of time while preserving excellent filtration performance.

The filter media 103 once scaled off/scraped off and reduced to discrete particles are caught by the tornado flow T of the treatment wastewater W1, moved downward and washed. As a result, the contaminants 112 which have adhered to the filter media 103 reduced to discrete particles are separated. When the discrete filter media 103, with the contaminants 112 separated, deviate from the tornado flow T, they float once again and form the filter layer 103a. Because the contaminants 112 which have scraped off have a specific gravity which is greater than that of the treatment liquid, they fall down in the filtration chamber, and after passing the separation member 108, enter the collector 110 and are precipitated at the bottom of the collector 110.

The intensity of the tornado flow T can be adjusted by adjusting the divergence of valves V1, V2 and V3. In other words, a tornado flow T can be obtained which has a sufficient intensity to enable scrape-off of the filter media 103 from a part of the bottom surface of the filter layer 103a while maintaining the layered structure of the filter layer 103.

The tornado flow T moving downwards while rotating crashes into the separation member 108 and therefore substantially no tornado flow T enters the collector 110. That is to say, the tornado flow T is not a simple downward flow but also rotates, the streams constituting the rotating flow crash into the separation member 108 which blocks the tornado flow T. Due to this, the treatment wastewater W1 inside the collector 110 enters substantially a state of stasis, whereas the contaminants 112 which have fallen inside the collector 110 are deposited at the bottom thereof.

In the filtration process, when a large amount of contaminants 112 have precipitated/accumulated inside the collector 110, valve V4 is opened and contaminants 112 deposited in the collector 110 are discharged to the exterior together with the treatment wastewater W1. In such a case, only a small amount of treatment wastewater is discharged to the exterior and therefore an environmentally-friendly filtration process can be easily carried out. Valve V4 can also be opened a little during the filtration process to evacuate the treatment wastewater. Also, it is also possible to discharge the treatment wastewater by closing valves V1, V2, V3 and V4 and opening valve V4.

When the filtration operation has been carried out for a long period of time and filtration performance has been reduced due to entry of a large amount of contaminants 112 inside the filter layer 103a, an operation to recover filtration performance is performed. In other words, the pump P1 is operated when valves V1 and V2 are opened and valves V3 and V4 are closed. Since all the treatment wastewater W1 supplied to the filtration chamber 109 is aspirated by the suction pipe 106, the downward flow inside the filtration chamber 109 becomes stronger thus enveloping all the filter media 103 and the filter layer 103a collapses. Basically, the tornado flow T grows to occupy the entire filtration chamber 109 and the filter media 103 are stirred inside a large portion of or the entire filtration tube 102 by the tornado flow T. Contaminants 112 which have adhered to the filter media 103 are thereby separated and filtration performance of the filter media 103 is recovered. In this case, the size of the tornado flow T can be adjusted by adjusting the divergence of valves V1 and V2. That means that by generating the spiral flow which rotates while sucking in filter media 103, the filter media 103 are rubbed and rotate to carry out washing of the filter media 103.

After the contaminants 112 have been removed from the filter media 103 by the grown tornado flow T, pump P1 is stopped. Individually separated filter media 103 float and re-form a filter layer 103a which has recovered its filtration performance.

Due to the hereinabove spiral flow of the treatment liquid, the bottom surface of the filter layer 103a is raised in a downward direction at a central portion thereof. That is, the bottom surface of the filter layer 103a has a funnel shape and the contact area between the bottom surface of the filter layer 103a and the treatment liquid increases. Consequently, filtration efficiency can be improved. In brief, by generating the tornado flow T, refresh of the filter media 103 can be carried out and furthermore, filtration surface of the filter layer 103a can be extended.

### MODIFICATION EXAMPLE

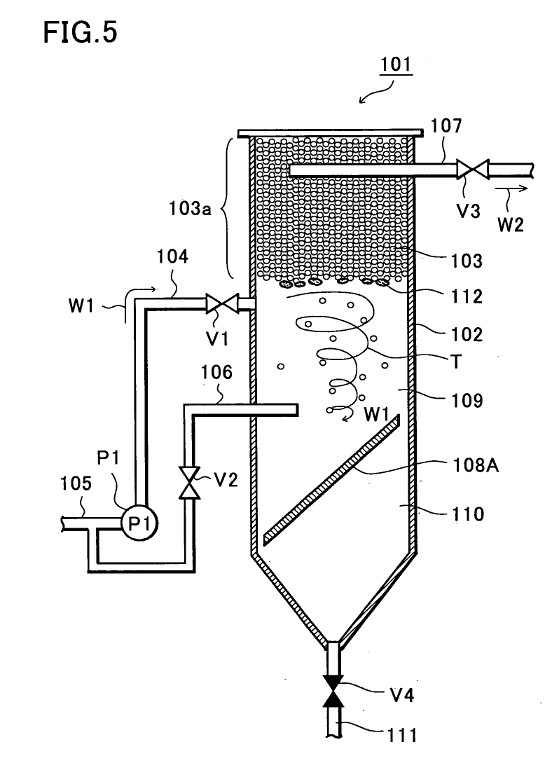

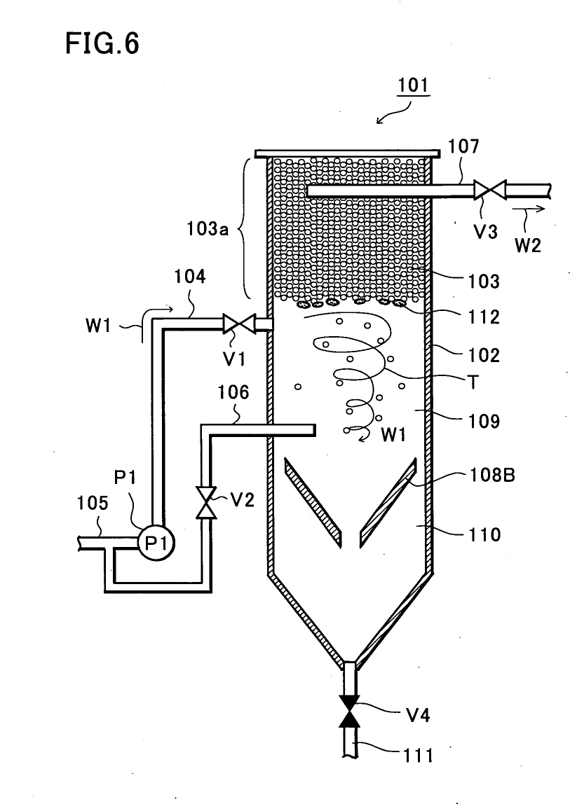

In the first embodiment, a cross-shaped (4-plate type) separation member 108 is used, but the number of plates may be increased or reduced. Plates may also be arranged in a double cross. For the separation member, punching metal, an oblique plate 108A as shown in FIG. 5 or a funnel-shaped member 108B as illustrated in FIG. 6 can be employed. Moreover, when a plurality of separation members are arranged unevenly in a vertical direction, the shapes of the separation members may be the same or they may very well be different. For instance, it is possible to have a structure where respective punching metals are arranged at an upper side and lower side of a cross-shaped (4-plate type) separation member 108.

In the oblique plate 108A shown in FIG. 5, an opening is formed between a lower end of the oblique plate 108A and an inner surface of the filtration tube 102, to enable passage of the contaminants 112 which further fall from the filtration chamber 109 into the collector 110. Additionally, an opening is formed between an upper end of the oblique plate 108 and an inner surface of the filtration tube 102 to enable passage of the filter media 103 which entered the collector 110 back to the filtration chamber 109.

With the funnel-shaped member 108B illustrated in FIG. 6, an opening is formed in the lower end at the center of the funnel-shaped member 108B to enable passage of the contaminants 112 which further fall from the filtration chamber 109 into the collector 110. Additionally, an opening is formed between a peripheral wall upper end portion of the funnel-shaped member 108B and an inner surface of the funnel-shaped member 108B to enable passage of the filter media 103 which entered the collector 110 back to the filtration chamber 109.

Also, the suction pipe 106 is coupled to the filtration chamber 109 at a position above the separation member 108, but it may very well be coupled at a position closer to the separation member 108 in the space of the collector 110. Furthermore, in case a plurality of separation members are arranged, the suction pipe 106 may be coupled at a position between the upper and lower separation members.

In the first embodiment, a separation member 108 was used but it is possible to omit it. In such a case, the size of the tornado flow T during the filtration process is optimally adjusted, in other words, the divergence of valves V1, V2 and V3 is adjusted to enable scrape off by the tornado flow T of the filtration media 103 from a part of the bottom surface of the filter layer 103a and to adjust the lower end of the tornado flow T so that it does not reach to the bottom surface of the filtration tube 102. In this manner, it is possible to preserve filtration performance of the filter layer 103a for a long period of time and at the same time, to prevent the contaminants 112 precipitated/deposited at the bottom of the filtration tube 102 from being raised up.

Furthermore, a supply pipe for filtration performance recovery, which pumps in treatment wastewater W1 in the direction of the inner wall of the filtration tube 102, is coupled to the filtration tube 102 at a portion where the filter layer 103a is formed. This supply pipe for filtration performance recovery has a valve and may be connected to the pump P1. The valve is closed during the normal filtration process but it is opened during the filtration performance recovery process. Since the treatment wastewater W1 is pumped in in a circumferential direction even at the portion where the filter layer 103a is formed, the filter layer 103a collapses very rapidly and the entire filter media 103 is rapidly caught up in the tornado flow T, therefore providing a rapid and reliable filtration performance recovery of the filter media 103.

Second Embodiment

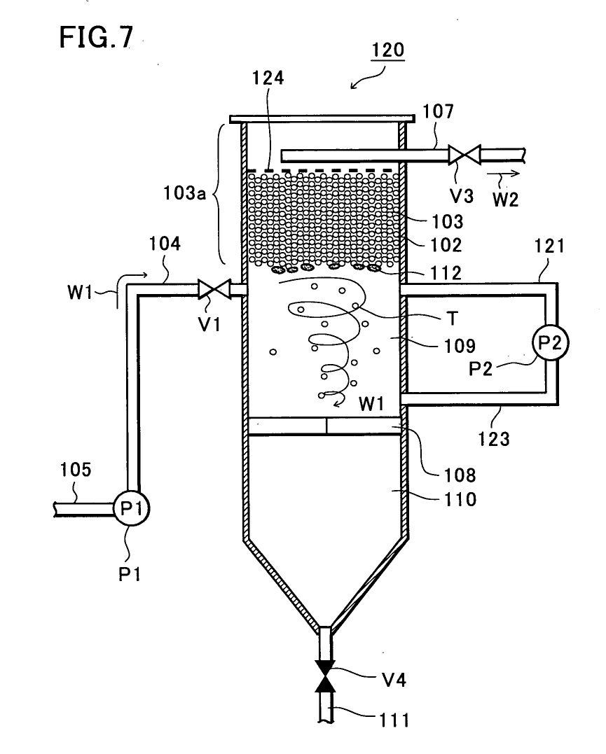

FIG. 7 illustrates a filtration device (apparatus) 120 according to a second embodiment regarding of the present invention. With this filtration device 120, treatment wastewater W1 fed via a treatment wastewater pipe 105 and a pump P1 is discharged from the supply pipe 104 into the filtration tube 102 and rotates/whirls inside a filtration chamber 109.

A second supply pipe 121 is coupled to the filtration tube 102. Similarly with the supply pipe 104, the supply pipe 121 is positioned obliquely relative to the radial direction of the filtration tube 102. In this case, the supply pipes 104 and 121 are positioned with directions thereof synchronized so that the rotation/whirling directions of the treatment wastewater W1 fed in can be coordinated.

A suction pipe 123 is coupled to the filtration tube 102 at a position lower than the contact position of the supply pipes 104 and 121 with the filtration tube 102. A pump P2 absorbs treatment wastewater W1 from a bottom location of the filtration chamber 109 via the suction pipe 123 and the treatment wastewater W1 so absorbed is discharged into an upper location of the filtration chamber 109 via the supply pipe 121.

A filter media net 124 is provided at an upper location of the filtration chamber 109. The size of the filtration net meshes is smaller than the particle diameter of the filtration media 103 and therefore, the floating filter media 103 are blocked by the filter media net 124, but the treated water W2 filtered through the filter layer 103a can pass through the filter media net 124.

A treated water pipe 107 is located in the filtration chamber 109 at an upper position than the filter media net 124 and enables evacuation of the treated water W2 to the exterior. In the present embodiment, the filter media net 124 and the treated water pipe 107 constitute a treated water discharge structure which can be applied to the first embodiment.

Configuration of other components is same as described in the first embodiment.

In the second embodiment, a tornado flow T is generated inside the filtration chamber 109 and the filter media 103 constituting a part of the bottom surface of the filter layer 103a is scraped off thereby improving filtration performance of the filter layer 103a. Substantially no tornado flow T is transmitted to the collector 110 and the treatment wastewater W1 of the collector 110 enters substantially a resting state thus allowing sedimentation/deposition of the contaminants 112 which were filtered and separated inside the collector 110.

Third Embodiment

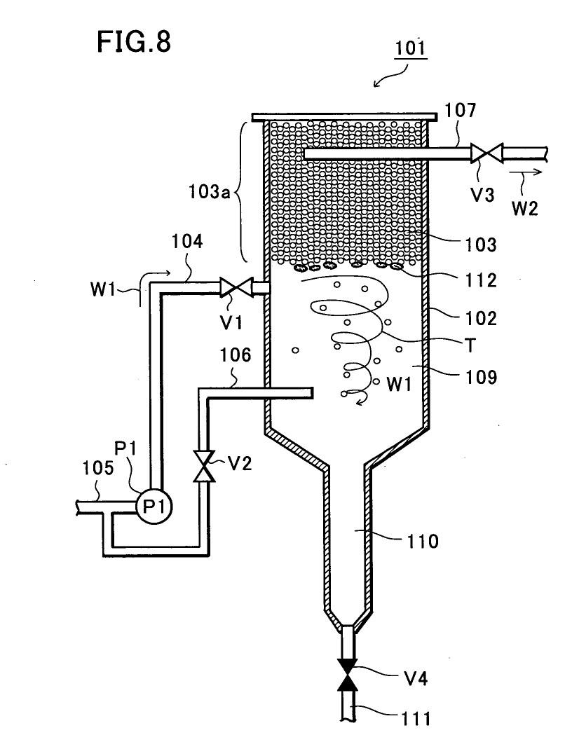

FIG. 8 shows a filtration device (apparatus) 101 of a third embodiment of the present invention. With this filtration device 101, the cross-sectional area of the lower portion of the filtration tube 102 where the collector is formed is smaller relative to the upper portion of the filtration tube 102 where the filtration chamber 109 is formed. Moreover, no separation member is provided therein. Configuration of other components is same as described in the first embodiment.

Because with this filtration device 101, the cross-sectional area of the lower portion forming the collector 110 is smaller, substantially no tornado flow T is transmitted to the bottom of the collector 110 and the contaminants 112 deposited/precipitated in the collector 110 are not raised.

In the filtration tube 102, the upper portion forming the filtration chamber 109 has a circular cylinder shape, but if the lower portion forming the collector 110 is made to have an angular cylinder shape, it is unlikely that the tornado flow T is transmitted to the bottom of the collector 110.

In all the embodiments, the tornado flow T is generated, in principle, at the tip portion of the supply pipe 104 and terminates in the vicinity of the suction pipe 106. Because of this, it is unlikely that the tornado flow T is transmitted below the suction pipe 106.

Fourth Embodiment

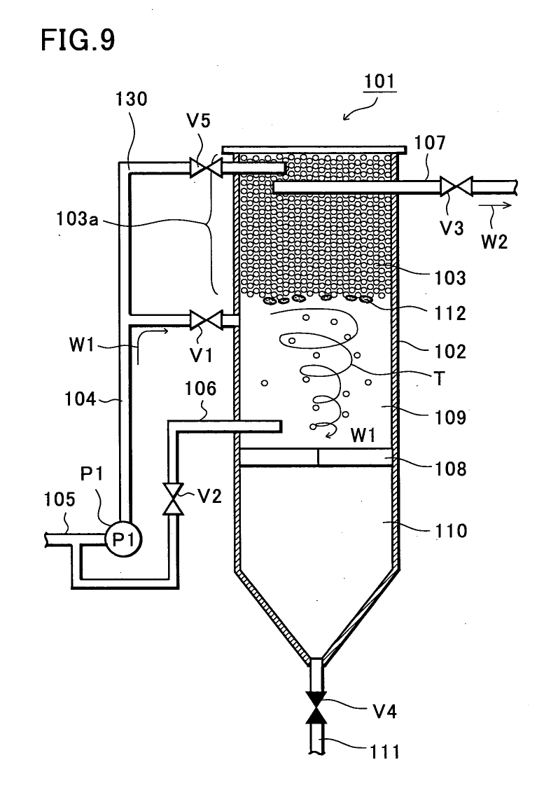

Next, the configuration and operation of a filtration device (apparatus) 101 according to a fourth embodiment will be described with reference to FIG. 9. The basic configuration of the filtration device 101 illustrated in this figure is same as the device described in the first embodiment, with the only difference that it comprises a backwash discharge pipe 130 as circulation means which will be described below.

One end of the backwash discharge pipe 130 as circulation means merges into a supply pipe 104 and is coupled to a pump P1. The other end of the backwash discharge pipe 130 is coupled to a filtration chamber 109 of a filtration container, preferably it is coupled to a filtration tube 102 at the location where a filter layer 103a is formed. A valve V5 is provided in the backwash discharge pipe 130. Similarly with the supply pipe 104, the backwash discharge pipe 130 is positioned obliquely relative to the radial direction of the filtration tube 102 and the treatment wastewater fed from the backwash discharge pipe 130 to the filtration tube 102 is pumped in along an inner wall of the filtration tube 102 so that inside the filtration tube 102, the treatment wastewater W1 rotates/whirl in a direction following the inner wall of the filtration tube 102. The rest of the configuration is same as described in the first embodiment.

During normal operation (during filtration), the fifth valve V5 is closed and therefore, when filtration process is carried out, there is no liquid discharge from the backwash discharge pipe 130. In other words, the backwash discharge pipe 130 is a pipe used only for filter media 103 washing purposes.

Next, the method of washing the filter media 103 using the backwash discharge pipe 130 will be described. First, the first valve V1 and the third valve V3 are closed and the second valve V2 and the fifth valve V5 are opened. The pump P1 is then operated to rotate the liquid fed from the suction pipe 106 by returning the same from the backwash discharge pipe 130 into the filtration tube 102. Consequently, a tornado flow T sucking in most of the filter media is generated and washing of the filter media 103 is carried out. The mechanism for carrying out washing of the filter media 103 by means of the tornado flow is same as described in the first embodiment.

In the process of washing the floating filter media 103, since the floating filter media 103 are washed by being caught up in the tornado flow, the tip portion of the treated water pipe 107 contacts liquid which was not filtered. Accordingly, repeating the washing operation of the floating filter media 103 may cause removables to adhere to the tip portion of the treated water pipe 107. In such cases, the treatment liquid is flow-reversed from inside the treated water pipe 107 to disperse the removables adhered thereto.

Fifth Embodiment.

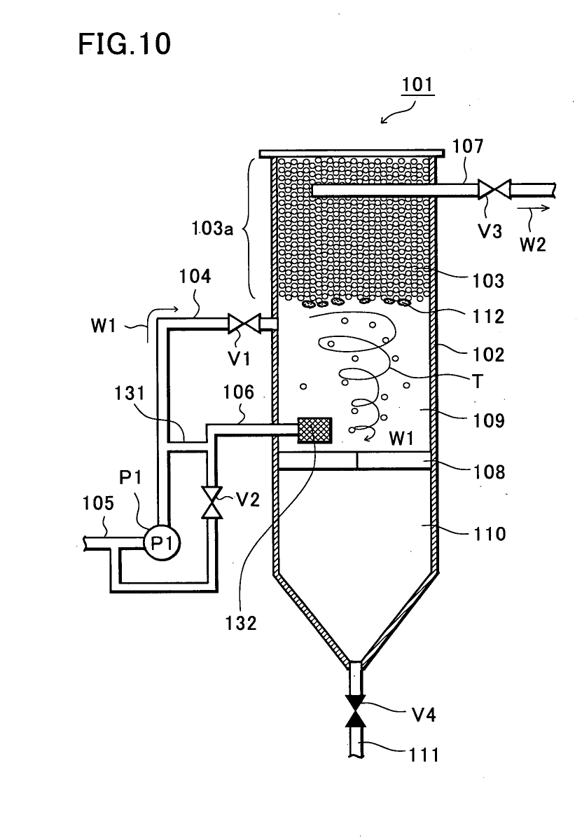

Next, the configuration and operation of a filtration device (apparatus) 101 according to a fifth embodiment will be described with reference to FIG. 10. The basic configuration of the filtration device 101 illustrated in this figure is same as the device described in the first embodiment, with the only difference that it comprises a capture means 132 and a bypass pipe 131 which will be described below.

The capture means 132 is provided so that it covers the suction section at the tip of the suction pipe 106. The capture means 132 have a function to prevent the filter media 103 which were separated from the filter layer 103a by the tornado flow, and the removables contained in the liquid from entering inside the suction pipe 106. Concretely, it is also possible to use, means similar with the elements illustrated in, for instance, FIG. 3A or FIG. 3B as capture means 132. By thus preventing filter media 103 and removables from entering the suction pipe 106, the capture means 132 also prevent destruction caused by filter media and by the removables entering the pump P1.

The bypass pipe 131 is a pipe that connects the suction pipe 106 with the supply pipe 104. Concretely, one end of the bypass pipe 131 is coupled to the suction pipe 106 at a location closer to the filtration tube 102 than the valve V2, whereas the other end of the bypass pipe 131 is connected to the supply pipe. The rest of the configuration is same as described in the first embodiment.

During the course of filtration, filter media 10 and removables, etc. adhere to the surface of the capture means 132 forming a layer which may inhibit the filtration properties of the filtration device 101. In such a circumstance, a reverse-flow operation using the bypass pipe 131 is carried out to remove the abovementioned layer deposited on the surface of the capture means 132. Concretely, valve V2 is closed and pump P1 is operated so that the liquid discharged by the pump passes through the bypass pipe 131 and suction pipe 106 and flows into the filtration tube 102. Accordingly, the layer formed on the surface of the capture means 132 is peeled off and is precipitated in the collector 110.

Structure of Sixth Embodiment

FIG. 11 illustrates a filtration device (apparatus) 201 using floating filter media being supplied with wastewater, according to a sixth embodiment of the present invention. The filtration device 201 is provided with a filtration tower 202 and a static tower 203 which are tubular members having a top surface and a lower surface thereof obstructed.

A plurality of granular floating filter media 204 are provided inside the filtration tower 202 which is a filtration container. As the filter media 204, very fine foam polystyrene particles, resin particles or inorganic material particles with a specific gravity smaller than 1 (for instance, a specific gravity of around 0.1) can be employed. Consequently, when wastewater W1 is supplied inside the filtration tower 202, the filter media 204 float and discrete filter media 204 are tightly pressed to form a dense structure. A filter layer 204a is formed by the floating filter media 204 thus enabling an accurate filtration. Particles of the filter media 204 have special dimensions within the range of, for example 0.05 mm˜3 mm (diameter) and filter media 204 formed of suitable material with optimal particle size according to the wastewater type are employed.

In FIG. 11, due to graphical considerations, filter media 204 are drawn sparsely, but they actually exist in a very compact condition. The particle size of the filter media 204 is extremely small but the figure shows particles having a larger size than their actual dimension.

A supply pipe 205 as a supply means having a valve V1 is coupled to the portion (lower portion) of the filtration tower 202 where a filter layer 204a with floating filter media 204 is not formed. Wastewater W1 aspirated by a pump P1 from a wastewater containment tank 297 via a suction pipe 206 used as a suction means is supplied to the supply pipe 205. The wastewater W1 discharged from the pump P1 is pumped into the lower space (space where the filter layer 204a is not formed) in the interior of the filtration tower 202 via the supply pipe 205.

Wastewater W1 supplied from the supply pipe 205, which is positioned obliquely with respect to the radial direction of the filtration tower 202, to the filtration tower 202 is pumped in along an inner wall of the filtration tower 202 and rotates (whirls) within the filtration tower 202 in a direction that follows the inner wall of the filtration tower 202, as shown in FIG. 2 which is a cross-sectional view.

In FIG. 11 and FIG. 2, the wastewater W1 is supplied by one supply pipe 205 only, but a plurality of supply pipes may be spacedly arranged in the circumferential direction of the filtration tower obliquely with respect to the radial direction of the filtration tower 202. In such a case, the plurality of supply pipes are arranged with directions thereof synchronized and the rotation/whirling direction of the wastewater supplied by the plurality of supply pipes is coordinated.

The supply pipe 205 is positioned obliquely with respect to the radial direction of the filtration tower 202, but it may also be inserted straight until the center of the filtration tower 202 and a nozzle may be provided at the tip of the supply pipe 205 for pumping in the wastewater in a circumferential direction. In other words, a structure is finally achieved where the wastewater is pumped in in a circumferential direction and rotation thereof is obtained.

To continue description of FIG. 11, a treated water pipe 208 as a discharge means is inserted in the filtration tower 202 at the portion (upper portion) where the filter media 204 float to form a filter layer 204a. The tip portion of the treated water pipe 208 which is inserted inside the filtration tower 202 has a drainage structure which enables permeation of the liquid but prevents permeation of the filter media 204. Description of the drainage structure is same as for the structure shown in FIG. 3.

With respect to FIG. 11, the portion (in the present embodiment, the lower end portion of the filtration tower 202) of the filtration tower 202 where the filter media 204 do not float to form a filter layer 204a and the upper portion of the static tower 203 are connected by a flow pipe 209. Further, the top of the static tower 203 and an intermediate portion of the suction pipe 206 are connected by a filter media return pipe 210. In this case, the suction pipe 206 is thick (for instance, a pipe diameter of 20 mm), whereas the flow pipe 209 and the filter media return pipe 210 is narrow (for instance, a pipe diameter of 6 mm).

An upper surface 203a of the static tower 203 is a circular conic section having an area which becomes narrower as it grows upward. A drainage pipe 211 provided with a valve V2 is coupled to the bottom surface of the static tower 203.

A backwash discharge pipe 212 provided with a valve V3, a filter media suction pipe 213 provided with a valve V4, a liquid suction pipe 214 provided with a valve V5, a liquid discharge pipe 215 provided with a valve V6 and a backwash suction pipe 216 provided with a valve V7 are coupled to the periphery (side surface) of the filtration tower 202 in this order in a downward direction.

Pipes 212 and 213 are connected to the filtration tower 202 at the portion (upper portion) where the filter media 204 float to form a filter layer 204a, whereas pipes 214, 215 and 216 are coupled to the filtration tower 202 at the portion (lower portion) where the filter media 204 does not float to form a filter layer 204a. To give a more detailed description of pipes 212 and 213, the backwash discharge pipe 212 is coupled to the filtration tower 202 at a position where an upper layer section of the filter layer 204a is formed, whereas the filter media suction pipe 213 is coupled to the filtration tower 202 at a position where a lower layer section of the filter layer 204a is formed.

Pipes 212 and 215 are coupled to the discharge section P2 out of the pump P2, whereas the pipes 213, 214 and 216 are coupled to the suction section P2 in of the pump P2.

The operation of a filtration device 201 having the abovementioned structure will be now described.

Filtration Operation

When carrying out the filtration process, valves V1, V4, V5 and V6 are opened and valves V2, V3 and V7 are closed in order to drive pumps P1 and P2. In other words, with respect to valves V1 to V7 shown in FIG. 11, the white-colored valves are opened whereas the black-colored valves are closed to drive pumps P1 and P2.

When the pump P1 is operated, wastewater W1 inside the wastewater containment tank 207 is absorbed through the suction pipe 206 and supplied to the filtration tower 202 via the supply pipe 105 to fill up the filtration tower 202. The wastewater W1 supplied to the filtration tower 202 is also supplied to the static tower 203 through a fine flow pipe 209 to fill up the static tower 203. At this time, because the fine filter media return pipe 210 is connected to the thick suction pipe 206, a negative pressure is generated when wastewater W1 inside the suction pipe 206 is absorbed by the pump P1 thus inducing a negative pressure inside the filter media return pipe 210, and the wastewater W1 inside the static tower 203 returns to the suction pipe 206 via the filter media return pipe 210. That is to say, wastewater W1 inside the static tower 203 is absorbed by the suction pipe 206 in accordance with a principle similar to an ejector.

When wastewater W1 is supplied to the filtration tower 202 to fill it up as described above, the floating filter media 204 having a small specific gravity float and discrete filter media 204 are tightly pressed to form a dense structure as illustrated in FIG. 11. Due to this, an extremely robust filter layer 204a is formed by the filter media 204 thus enabling micro-filtration.

Wastewater W1 is treated by circulating in the filter layer 204a in an upward direction. The thus treated liquid, the treated water W2 is discharged via a treated water pipe 208. Since all impurities 217 contained in the wastewater W1 are filtered/removed, the treated water W2 is clear and it can be directly discharged into the environment without any risk of causing environmental damage. The treated water W2 can also be re-used as industrial water in industrial plants, etc.

Impurities 217 contained in the wastewater W1 gravitate downward by their own weight and fall to the bottom of the filtration tower 202. These impurities 217 are supplied together with the wastewater W1 into the static tower 203 via the flow pipe 209. That is, the filtered/separated impurities 217 are transferred from the filtration tower 202 into the static tower 203.

The static tower 203 is a tower separated from the filtration tower 202 and the wastewater W1 contained therewithin does not have a turbulent flow, but instead it enters a substantially resting state due to the fact that the flow pipe 209 is fine and the wastewater W1 flows into the static tower 203 calmly. Consequently, the impurities 217 transferred into the static tower 203 together with the wastewater W1 settle down and are deposited at the bottom of the static tower 203.

There are cases when, because the wastewater W1 is supplied from the filtration tower 202 to the static tower 203 via the flow pipe 209, a part of the filter media 204 is also transferred to the static tower 203. The filter media 204 thus entering the static tower 203 float and accumulate at the top portion of the static tower 203. Then, together with the wastewater W1, the filter media 204 are returned to the suction pipe 206 via the filter media return pipe 210 and further to the filtration tower 202 via the supply pipe 205.

The filtration process is continued and impurities 217 temporarily adhere to the bottom surface of the filter layer 204a as shown in FIG. 11. At this time, the wastewater W1 supplied from the supply pipe 205 to the filtration tower 202 is pumped in along an inner surface of the filtration tower 202 and rotates/whirls in a space lower than the filter layer 204a of the filtration tower 202. The rotating flow triggers scrape-off/detachment of a part of the filter media 204 in the bottom surface of the filter layer 204a and, together with this, a scaling off of the impurities 217 that have temporarily adhered to the bottom surface of the filter layer. As a result, a new surface free of any impurities 217 is gradually formed at the bottom surface of the filter layer 204a made of filter media 204 thus rendering clogging unlikely to appear. A filtration operation is therefore enabled which preserves excellent filtration performance over a long period of time.

The filter media 204 once scraped off/detached and reduced to discrete particles are rotated by the rotating flow of wastewater W1 to separate the impurities 217 and then float again to form the filter layer 204a. The thus separated impurities 217 fall to the bottom of the filtration tower 202 and are transferred to the static tower 203.

In the filtration process described above, valves V3 and V7 are closed and valves V4, V5 and V6 are opened to drive pump P2. The wastewater W1 is thereby absorbed from the liquid suction pipe 214 towards the pump P2, whereas a mixture of filter media 204 and wastewater W1 is absorbed from the filter media suction pipe 213 towards the pump P2. The pump P2 mixes the wastewater W1 with the filter media 204 thereby causing separation from the surface of the filter media 204 of impurities 217 such as dirt and adhesive matter, etc. that have adhered to the surface thereof, which leads to a recovery of the filtration properties of filter media 204. The plurality of filter media 204 agglomerated by the adhesive matter are reduced to discrete particles and the dirt and adhesive matter which have adhered to the surface of the individually separated filter media 204 are scraped off from the surface thereof to recover the filtration properties of the filter media 204.

The wastewater W1 and the filter media 204 whose filtration properties have been recovered in the pump P2 are discharged from the pump P2 and are pumped in into the lower space (the space where no filter layer 204a is formed) of the filtration tower 202 via the liquid discharge pipe 215. The filter media 204 thus pumped in float to form the filter layer 204a once again.

Accordingly, the filter layer 204a, especially the filter media 204 of the bottom layer portion thereof are gradually absorbed by the filter media suction pipe 213 and the filter media 204 which recovered their filtration properties gradually return thus allowing the filter media 204 to flow little by little. As a result, the impurities 217 which entered this portion (the bottom layer portion of the filter layer 204a) cannot move upward any further and are thus transferred together with the filter media 204 to a lower space (the space where no filter layer 204a is formed) of the filtration tower 202 via the filter media suction pipe 213, the pump P2 and the liquid discharge pipe 215. The bottom layer portion of the filter layer 204a is thereby refreshed by the filter media 204 that have recovered their filtration properties, which results in filter media 204 having constant high filtration performance and a filter layer having high filtration performance.

On the other hand, in the upper layer portion of the filter layer 204a, the movement of the filter media 204 is substantially inexistent and filter media 204 are continuously tightly pressed to form a dense structure thus enabling a reliable preservation of filtration properties. Accordingly, polluted liquid is prevented from being washed out from the treated water pipe 208.

All in all, the constant high filtration performance of the bottom layer portion in the filter layer 204a and the reliable preservation of filtration properties in the upper lower portion thereof enable preservation of excellent filtration properties of the filter layer 204a over a long period of time. In other words, filtration performance of the filter layer 204a is maintained over a long period of time without the need to use a rabbler or the like to mix the filter media 204a.

Because a mixture formed of filter media 204 and wastewater W1 is absorbed by the filter media suction pipe, and, additionally wastewater W1 is also absorbed by the liquid suction pipe 214 simultaneously as described hereinabove, the filter media 204 flow smoothly without clogging in the pipe or pump P2.

In a case when, for instance, the mixture of filter media 204 and wastewater W1 is absorbed only by the filter media suction pipe 213, without the use of the liquid suction pipe 214, clogging occurs immediately. This result is confirmed by experiments. That is, the point here is that the mixture formed of filter media 204 and wastewater W1 is absorbed by the filter media suction pipe, and moreover, the wastewater W1 is also absorbed by the liquid suction pipe 214 simultaneously, thus enabling absorption/circulation of the filter media 204 without clogging.

Backwash Process

When filtration process has been carried out over a long period of time, the impurities 217 enter inside the filter layer 204a which thereby clogs and the flow rate of the treated water W2 discharged from the treated water pipe 208 is reduced. In such circumstances, a backwash process is carried out. In case of clogging, impurities 217 such as metal particles, etc. are trapped in the spaces between discrete filter media 204 forming the filter layer 204a, that is, concentration of impurities 217 such as metal particles, etc. trapped in the filter layer 204a increases.

In backwash process, valves V1, V2, V4, V5 and V6 are closed, whereas valves V3 and V7 are opened and pump P1 is halted to drive pump P2. In other words, with respect to valves V3 to V7, the valves in FIG. 11 which are white-colored are now closed, whereas the valves in FIG. 11 which are black-colored are now opened. Next, the pump P2 is driven.

The wastewater W1 existent in the lower space of the filtration tower 202 is thereby absorbed in the pump P2 via the backwash suction pipe 216 and the wastewater W1 discharged from the pump P2 is pumped into the upper layer portion of the filter layer 204a formed inside the filtration tower 202, via the backwash discharge pipe 212.

Due to the wastewater W1 being thus pumped into the upper layer portion of the filter layer 204a, the filter layer 204a collapses and is separated in discrete filter media 204. Furthermore, inside the filtration tower 202, the wastewater W1 flows from an upper portion (discharge section of the backwash discharge pipe 212) towards a lower portion (suction section of the backwash suction pipe 216) and the discretely separated filter media 204 are dispersed throughout the entire inner space of the filter tower 202 to be mixed up. Consequently, impurities 217 such as metal particles, etc. entrapped among the filter media 204 are dispersed in the entire liquid filling the inner space of the filtration tower 202, to be separated from the discrete filter media 204. In other words, the impurities 217 entrapped among the filter media 204 are released in the liquid.

Next, operation of the pump P2 is halted and the filter media 204 inside the filtration tower 202 float to form the filter layer 204a once again. The thus re-formed filter layer 204a is formed of filter media 204 which are free of impurities and therefore this newly formed filter layer 204a has high filtration performance.

When backwash process as described above is terminated, the normal filtration operation is returned to. If it happens that during the backwash operation, a part of the filter media 204 should move to the static tower 203 via the flow pipe 209, the filter media 204 which entered the static tower 203 return to the filtration tower 202 via the filter media return pipe 210, suction pipe 206, pump P1 and supply pipe 205, during the filtration process.

Drain Discharge Process

When the filtration process is carried out over a long period of time, a large amount of impurities are deposited at the bottom of the static tower 203. When the amount of sediment becomes large, the valve V2 is opened and the impurities 217 are discharged together with the wastewater W1 via a drainage pipe 211. At this time, the filter media 204 inside the static tower 203 float in the upper portion of the static tower 203 and therefore are not discharged to the exterior during drain discharge.

A drainage pipe provided with a valve may also be coupled to the bottom of the filtration tower 202. In such a case, impurities, etc. accumulated at the bottom of the filtration tower 202 can be discharged to the exterior.

Structure of Seventh Embodiment

FIG. 12 shows a filtration device (apparatus) 201A using floating filter media according to a seventh embodiment of the present invention. The filtration device 201A according to the seventh embodiment has a structure which adds a filter media net 150 and a separation member 151 to the filtration device 201 described in the sixth embodiment.

The filter media net 150 having a mesh diameter smaller than the particle size of the filter media 204, is provided inside the filtration tower 202 at a position in the vicinity of a top surface thereof. Accordingly, the floating filter media 204 are blocked by the filter media net 150 and are prevented from moving to an upper position than the filter media net 150. Nevertheless, it is obvious that the treated water W2 can pass through the filter media net 150 and move upwards.

The treated water pipe 208 is a common pipe section which discharges to the exterior of the filtration tower 202 the treated water W1 which passed through the filter layer 204a and the filter media net 150.

A separation member 151 is positioned in the inner space of the filter tower 202 in a space where no filter layer 204a is formed. The separation member 151 has a circular conic opening whose surface area becomes smaller as it extends downward, the lower end thereof being lower end opening 151a. The member 151 is supported in the inner surface of the filtration tower 202 by a support member not illustrated here.

A hole which becomes a filter media passage clearance 152 is formed in the separation member 151, furthermore, the outer diameter of the upper side of the separation member 151 is smaller compared to the inner diameter of the filtration tower 202, the interval therebetween constituting a filter media passage clearance 153.

During the filtration process, a turbulent flow such as a rotating flow, etc. of the wastewater W1 is generated in a space above the separation member 151, whereas the wastewater W1 enters a substantially resting state in a space below the separation member 151. Accordingly, impurities 217 which have fallen down below the separation member 151 are prevented from returning into the filter layer 204a and an effective filtration is thereby enabled. The filter media 204 entering below the separation member 151 return into the filter layer 204a via the filter media passage clearance 152 and 153.

Configuration and operation of the other elements is same as described with respect to the filtration device 201 according to the sixth embodiment of the invention.

Eighth Embodiment

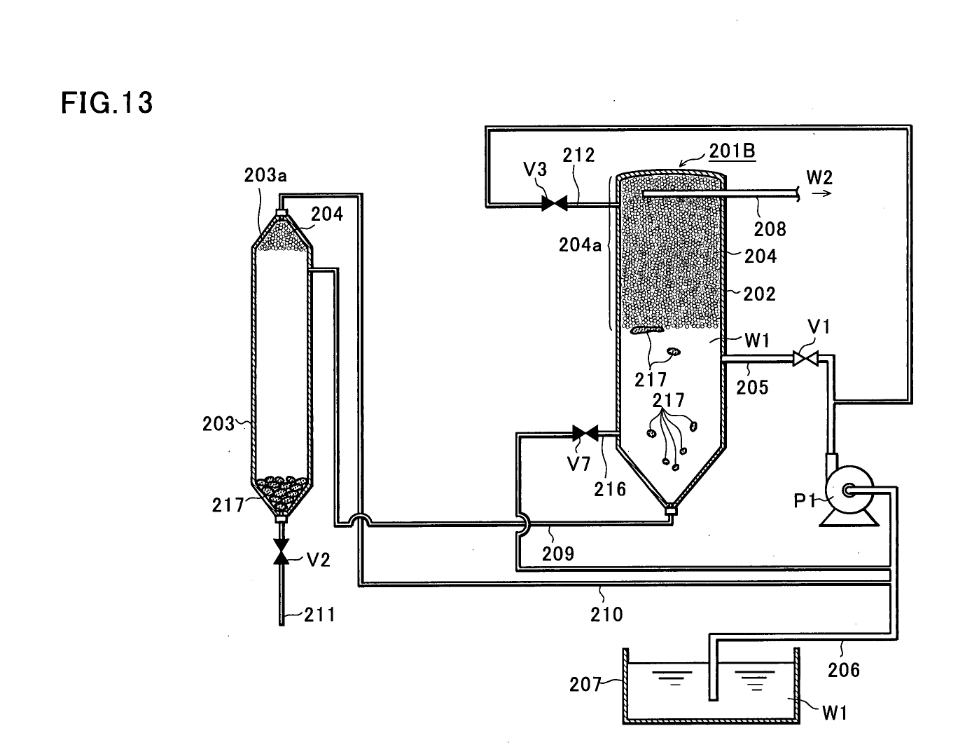

FIG. 13 shows a filtration device (apparatus) 201B using floating filter media, according to an eighth embodiment of the invention. In the filtration device 201B of this embodiment, a backwash discharge pipe 212 is coupled to a discharge side of a pump P1 and a backwash suction pipe 216 is coupled to a suction side of the pump P1 thus enabling filtration and backwash processes by the pump P1. Accordingly, pump P2, pipes 214, 215, 216, etc. employed in the first and second embodiments of this invention are not used herein.

During the filtration process according to this embodiment, valve V1 is opened and valves V2, V3 and V7 are closed to drive pump P1. Alternatively, during the backwash process, valves V1 and V2 are closed and valves V3 and V7 are opened to drive pump P1. In such a manner, it is possible to carry out processes similar to the filtration and backwash processes described in the first and second embodiments of this invention.

Ninth Embodiment

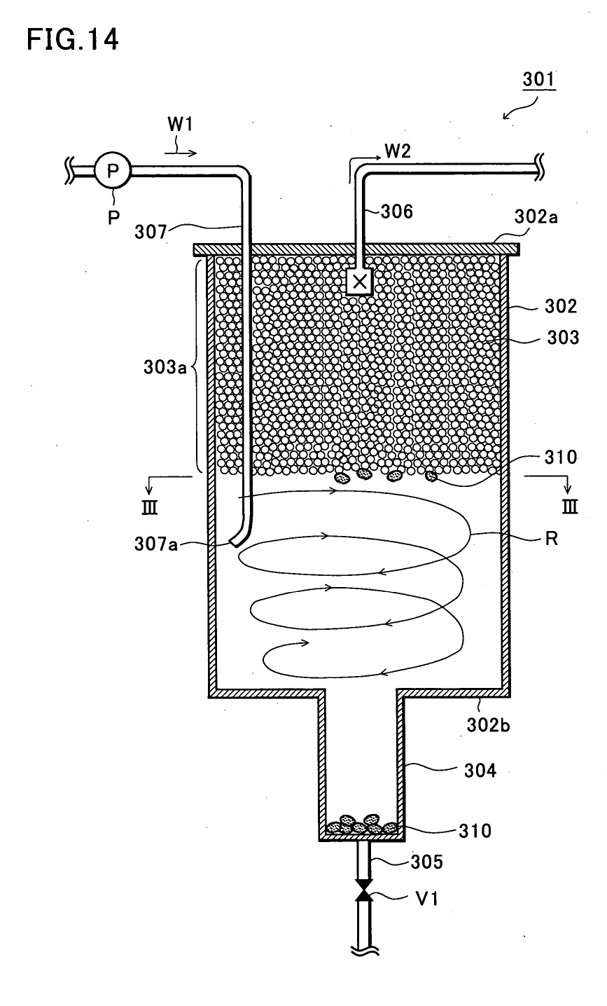

FIG. 14 shows a filtration device (apparatus) 301 using floating filter media, according to a ninth embodiment of the invention. This figure illustrates a state where treatment wastewater W1 (water comprising solid components of metal particles, paint components or sludge) such as polluted liquid, etc. is supplied into the filtration device 301. A filtration section 302 of the filtration device 301 has a cylindrical shape and is positioned (fixed, attached) such that the axis thereof follows a vertical direction. In this embodiment, a top surface of the filtration section 302 is obstructed by a top lid 302a, whereas a bottom surface thereof is obstructed by a bottom lid 302b. The shape of the filtration section 302 is not limited to a cylindrical shape and other polygonal tube shapes may be used.

A plurality of granular floating filter media 303 are provided inside the filtration section 302 which is a filtration container. Fine foamed polystyrene particles, resin particles or inorganic matter particles which have a smaller specific gravity (concretely, in case the main component of the treatment wastewater W1 is water, a specific gravity smaller than 1) than the treatment wastewater W1 are used for the filter media 303. Accordingly, when the treatment wastewater W1 is supplied inside the filtration section 302, the filter media 303 float such that the discrete filter media 303 are tightly pressed to form a dense structure. A filter layer 303a is thereby formed by the floating filter media 303 and an accurate filtration is enabled. Particles of the filter media 303 have special dimensions within the range of, for example 0.05 mm˜3 mm (diameter), and filter media 303 formed of suitable material with optimal particle size according to the wastewater type are employed.

A cylindrical precipitation chamber 304 as a collector is coupled to the bottom of the filtration section 302 to allow communication therebetween. The cross-sectional area of the precipitation chamber 304 is smaller than that of the filtration section 302 and the precipitation chamber 304 is positioned in a central portion (central portion along a radial direction) of the filtration section 302. In other words, the axial center of the precipitation chamber 304 and the axial center of the filtration section 302 substantially match.

A drainage pipe 305 provided with a valve V1 is coupled to the bottom of the precipitation chamber 304.

A treated water pipe 306 as a discharge means is inserted into the filtration section 302 at the portion where the filter media 303 float to thereby form the filter layer 303a. The tip section of the treated water pipe 306 inserted inside the filtration section 302 has a drainage structure that enables permeation of the liquid but prevents permeation of the filter media 303. Details of the drainage structure are same as for the structure illustrated in FIG. 3.

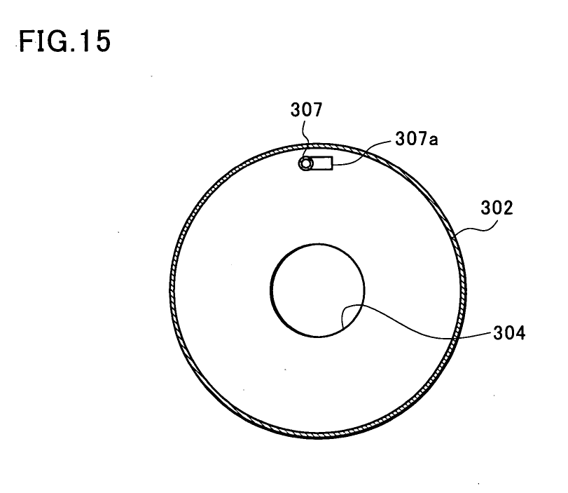

A supply pipe 307 as a supply means is passed through the top lid 302a of the filtration section 302 to be inserted inside the filtration section 302 and is installed such that it is oriented downwards (vertical position) for the portion where the filter layer 303a is formed. A tip opening 307a is positioned below the position where the filter layer 303a is formed. A tip section of the supply pipe 307 (a portion including the tip opening 307a) is bent in a direction along the inner wall of the filtration section 302, as shown in FIG. 15 which is a cross-sectional view along the III-III line in FIG. 14.

Treatment wastewater W1 supplied to the supply pipe 307 by a pump P passes through the supply pipe 307 and flows downwardly at the location where the filter layer 303a is formed to be discharged from the tip opening 307a. At this time, the tip section of the supply pipe 307 is bent in a direction following the inner wall of the filtration section 302 which causes the discharged treatment wastewater W1 to rotate/whirl in a direction following the inner wall of the filtration section 302. In FIG. 14, the rotating/whirling flow of the treatment wastewater W1 is shown by symbol R.

The operation of the filtration device 301 having the abovementioned structure will be now described.

In the filtration process, valve V1 is closed to drive pump P. The treatment wastewater W1 is thereby supplied inside the filtration section 302 via the pump P and the supply pipe 307 to fill up the inside of the filtration section 302.

When the treatment wastewater W1 is thus supplied into the filtration section 302, the floating filter media 303 having a small specific gravity float, as shown in FIG. 14 and the discrete filter media 303 are tightly pressed to form a dense structure. Consequently, a very robust filter layer 303a is formed by the filter media 303 thereby enabling micro-filtration.

The treatment wastewater W1 circulates among the filter media 303 forming the filter layer 303a in an upward direction and is thereby filtered. The so-treated water W2 is discharged via a treated water pipe 306. The treated water W2 is clear as contaminants have been filtered/removed and it can be directly discharged into the external environment without any risk of causing environmental damage. The treated water W2 can also be re-used as industrial water in industrial plants, etc. When the wastewater is acidic or alkaline, etc., a chemical neutralization process is carried out as needed before discharge into the environment.

Contaminants 310 (solid components) contained in the treatment wastewater W1 are separated through filtration, gravitate to the bottom of filtration section 302 (in a space at a lower position than the filter layer 303a of the filtration section 302), and fall down to be precipitated inside the precipitation chamber 304. Because the treatment wastewater W1 rotates/whirls inside the filtration section 302 in a direction following the inner wall of the filtration section 302, contaminants 310 which settle down accumulate at the central portion of the filtration section 302. As a result, contaminants 310 thereby accumulated at a central portion settle down/are deposited efficiently in the precipitation chamber 304 whose axial center substantially coincides with the axial center of the filtration section 302.

Because the cross-sectional area of the precipitation chamber 304 is smaller than the cross-sectional area of the filtration section 302, no rotating/whirling flow R of the treatment wastewater W1 reaches the bottom of the precipitation chamber 304 and thus, the flow of the of the treatment wastewater W1 at the bottom of the precipitation chamber 304 is extremely reduced. Contaminants 310 settled down/deposited at the bottom of the precipitation chamber 304 are prevented from soaring and returning back to the filtration section 302.

The rotating/whirling flow R of the treatment wastewater W1 can be even more efficiently prevented from entering inside the precipitation chamber 304 if an angular tube is employed for the precipitation chamber 304.

Because a rotating/whirling flow R of the treatment wastewater W1 is generated inside the filtration section 302, a part of the filter media 303 in the bottom surface of the filter layer 303a are scraped off/scaled off by the rotating/whirling flow R, and with this, contaminants 310 which have temporarily adhered to the bottom surface of the filter layer are scaled off. As a result, the gradual forming of a new surface free of contaminants 310 renders clogging in the bottom surface of the filter layer 303a formed of filter media 303 unlikely to occur. It is therefore possible to carry out the filtration process over a long period of time while preserving excellent filtration performance.

The filter media 303 once scraped off/scaled off and reduced to discrete particles are caught by the rotating/whirling flow R of the treatment wastewater W1 and washed. As a result, the contaminants 310 which have adhered to the filter media 303 reduced to discrete particles are separated and eliminated. The discrete filter media 303 with the contaminants 112 separated therefrom float once again to form the filter layer 303a, whereas the contaminants 112 which have been scraped off fall down along the filtration section 302, enter the precipitation chamber 304 are precipitated at the bottom thereof.

In the filtration process, when a large amount of contaminants 310 have been precipitated/accumulated inside the precipitation chamber 304, valve V1 is opened and contaminants 310 deposited in the precipitation chamber 304 are discharged to the exterior together with the treatment wastewater W1 via the drainage pipe 305. In this case, the cross-sectional area of the precipitation chamber 304 is smaller than that of the filtration section 302, therefore, even if the amount of the treatment wastewater W1 discharged to the exterior is small, an effective discharge to the exterior of the contaminants 310 concentrated and deposited inside the narrow precipitation chamber 304 can be carried out. Moreover, the amount of the treatment wastewater W1 simultaneously discharged to the exterior is small.

When no treatment wastewater W1 is supplied inside the filtration section 203, the filter media 303 fall down. Similarly, when the treatment wastewater W1 supply from the supply pipe 307 to the filtration section 302 is halted (filtration process is halted) and the valve V1 is opened to discharge the treatment wastewater to the exterior via the drainage pipe 305, the filter media 303 gravitate downward together with the treatment wastewater W1. Even if the filter media 303 fall down or gravitate downward as described, they do not enter into (flow-reverse) the supply pipe 307.

The reason for such is that the supply pipe 307 is positioned such that it is oriented downwards (vertical position) for the portion where the filter layer 303a is formed and the tip opening 307 thereof is positioned below the position where filter layer 303a is formed.

When the treatment wastewater W1 is supplied inside the filtration section 302 via the supply pipe 307, while the filter media 303 are settled down/precipitated at the bottom thereof, the filter media 303 move upwards. However, since at this time, the treatment wastewater W1 flows downward inside the supply pipe 307, the filter media 303 are prevented from entering inside the supply pipe 307.

In conclusion, even in a case when the filter media 303 gravitate downwards or in a case when the filter media 303 which settled down move upwards, the filter media are prevented from reverse-flowing into the supply pipe 307. Accordingly, fine filter media 303 do not reach the pump P and breakdown thereof due to the filter media 303 causing halting or clogging can be prevented.

Tenth Embodiment

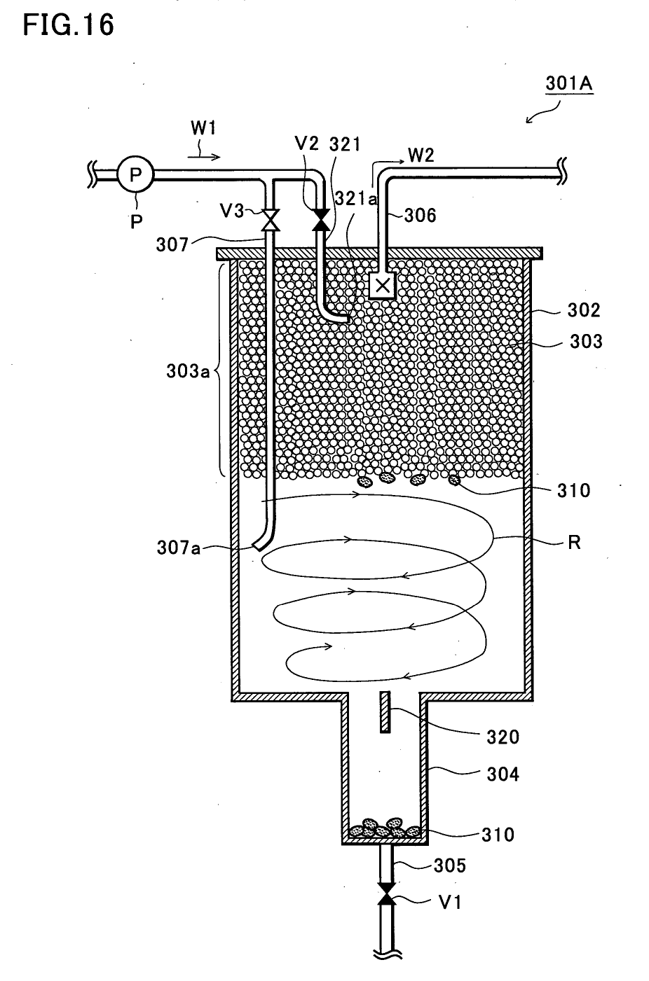

FIG. 16 illustrates a filtration device (apparatus) 301A using floating filter media according to a tenth embodiment of the present invention. With this filtration device 301A, a plate-like separation member 320 is provided at the portion (upper space) in the vicinity of a filtration section 302 in the inner space of a precipitation chamber 304.

A filtration performance recovery pipe 321 branches off at a medial part of a supply pipe 307, penetrates an upper lid 302a of the filtration section 302 to enter inside the filtration section 302 and a tip opening 321a thereof is positioned at a portion where a filter layer 303a is formed. In other words, the tip opening 321a is positioned inside the filter layer 303a when the treatment wastewater W1 is supplied inside the filtration section 302 to form the filter layer 303a. A tip section of the pipe 321 (a portion including the tip opening 321a) is bent in a direction following the inner wall of the filtration section 302, similarly with the tip section of the supply pipe 307.

A valve V2 is provided in a supply pipe 321 and a valve V3 is provided in a supply pipe 307 in a downstream portion lower than the branch portion. Configuration of other elements is same as described in the ninth embodiment shown in FIG. 14.

During the filtration process, valves V1 and V2 are closed and valve V3 is opened to drive pump P. A rotating/whirling flow of the treatment wastewater W1 is generated in the filtration section 302. This flow is trying to enter inside the precipitation chamber 304 but it crashes into the separation member 320 and therefore such entrance is prevented. The turbulent flow of the treatment wastewater W1 generated inside the precipitation chamber 304 crashes into the separation member 320 and the flow thereof is decreased until it stops. Accordingly, the flow of the treatment wastewater W1 at the bottom of the precipitation chamber 304 becomes extremely small and contaminants 310 precipitated/deposited at the bottom of the filtration chamber 304 are prevented from soaring and from returning inside the filtration section 302.

When the filtration operation has been carried out for a long period of time and filtration performance has been reduced due to entry of a large amount of contaminants 310 inside the filter layer 310a, an operation to recover filtration performance is performed. In other words, the pump P1 is operated when valve V2 is opened and valves V1 and V3 are closed. The treatment wastewater W1 is then discharged from the tip opening 321a of the filtration performance recovery pipe 321 thus inducing collapse of the filter layer 303a formed by the filter media 303. However, the treatment wastewater W1 discharged from the tip opening 321a rotates/whirls in a direction following the inner wall of the filtration section 302 thereby generating a rotating/whirling flow of the wastewater W1 inside the entire filtration section 302 which stirs all filter media 303 inside the filtration section 302. Contaminants 310 which have adhered to the filter media 303 are thereby separated and filtration performance of the filter media 103 is recovered.

After the contaminants 310 have been removed from the filter media 303 by the rotating/whirling flow R, pump P1 is halted. Individually separated filter media 303 float to re-form a filter layer 303a which has recovered its filtration performance.

Eleventh Embodiment

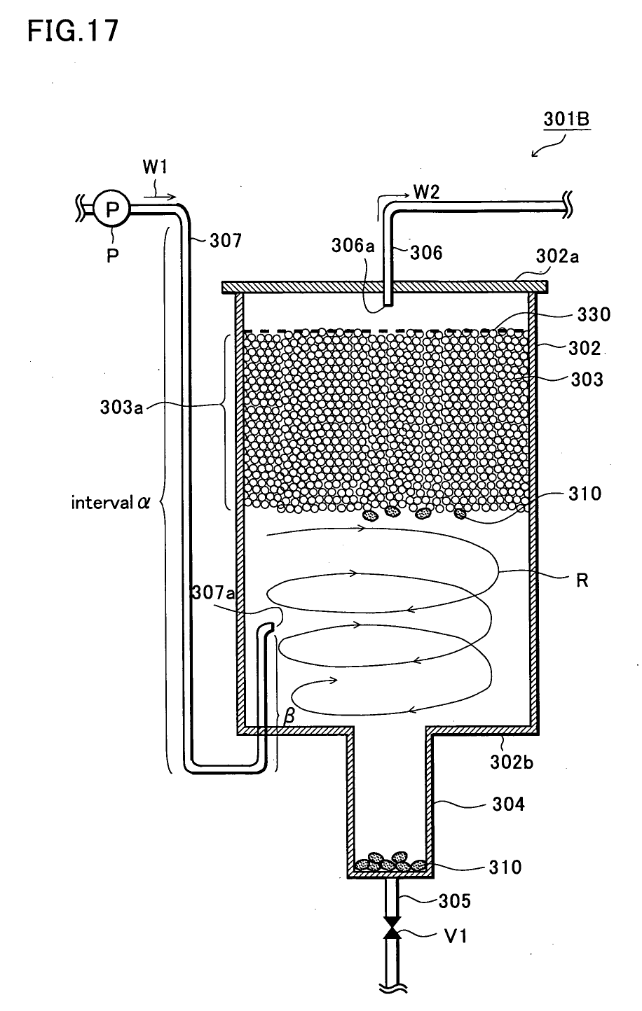

FIG. 17 shows a filtration device (apparatus) 301B using floating filter media according to an eleventh embodiment of the present invention. With this filtration device 301B, a filter media net 330 is provided at an upper portion of an inner space in a filtration section 302. Filter media 303 are filled in the inner space of the filtration section 302 under the filter media net 330. The mesh diameter of the filter media net 330 is smaller than the size of the filter media 303 used. When the treatment wastewater W1 is supplied inside the filtration section 302, a filter layer 303a is formed at a lower position than the filter media net 303.

A treated water pipe 302 is inserted in the inner space of the filtration section 302 at a position above the filter media net 330. The treated water pipe 306 is a common pipe which does not have the drainage structure illustrated in FIG. 17. Because the filter media 303 are blocked by the filter media net 330, the treated water W2 which passed through the filter layer 303a and further through the filter media net 330 can be discharged to exterior via the treated water pipe 306. A supply pipe 307 derived from the pump P is installed (interval α) at an outside position (adjacent space) of the filtration section 302 so that it is oriented downwardly in the portion where the filter layer 303a is formed (vertical position), then, this direction is reversed so that the supply pipe 307 penetrates a lower lid 302b of the filtration section 302 to extend (interval β) in an upward direction inside the filtration section 302 until a tip opening 307a reaches a position lower than the position where the filter layer 303a is formed. The treatment wastewater W1 discharged from the tip opening 307a of the supply pipe 307 rotates/whirls in a direction following the inner wall of the filtration section 302.

The configuration of the other elements is as described with reference to the ninth embodiment.

With the present embodiment, in interval α, the supply pipe 307 is positioned so that it is oriented downwardly in a portion (vertical position) where the filter layer 303a is formed. Accordingly, even if the filter media 303 fall/gravitate downward when the filtration operation is halted and water level of the treatment wastewater W1 inside the filtration section 302 drops, such filter media 303 may enter interval α of the supply pipe 307 but however, are prevented from entering and moving upward in interval α thereof. As a result, filter media 303 do not reach the pump P and halting or clogging of the pump P can be prevented.

Twelfth Embodiment

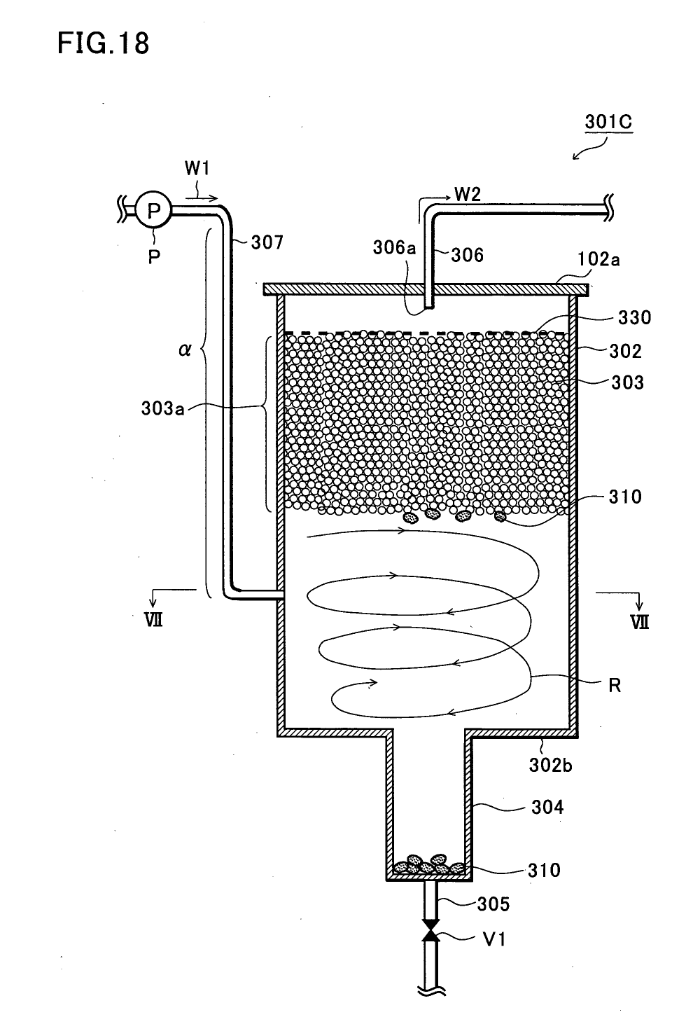

FIG. 18 shows a filtration device (apparatus) 301C using floating filter media according to a twelfth embodiment of the present invention. With this embodiment, a supply pipe 307 derived from a pump P is installed (interval α) at an outside position (adjacent space) of the filtration section 302 so that it is oriented downwardly in the portion where the filter layer 303a is formed (vertical position), then, this direction extends horizontally and perpendicular to a lateral surface (peripheral surface) of the filtration section 302 to which it is connected. The supply pipe 307 can also be positioned obliquely with respect to the radius of the filtration section 302, as shown in FIG. 2. Accordingly, treatment wastewater W1 is discharged from the supply pipe 307 into the filtration section 302 in a direction following the inner wall of the filtration section 302 and rotates/whirls inside the filtration section in a direction following the inner wall thereof.

The configuration of the other elements is as described with reference to the eleventh embodiment shown in FIG. 17.

With the present embodiment, in interval α, the supply pipe 307 is positioned so that it is oriented downwardly in a portion (vertical position) where the filter layer 303a is formed. Accordingly, even if the filter media 303 fall/gravitate downward when the filtration operation is halted and water level of the treatment wastewater W1 inside the filtration section 302 drops, such filter media 303 are prevented from entering and moving upward in interval α thereof. As a result, filter media 303 do not reach the pump P and halting or clogging of the pump P can be prevented.

Thirteenth Embodiment

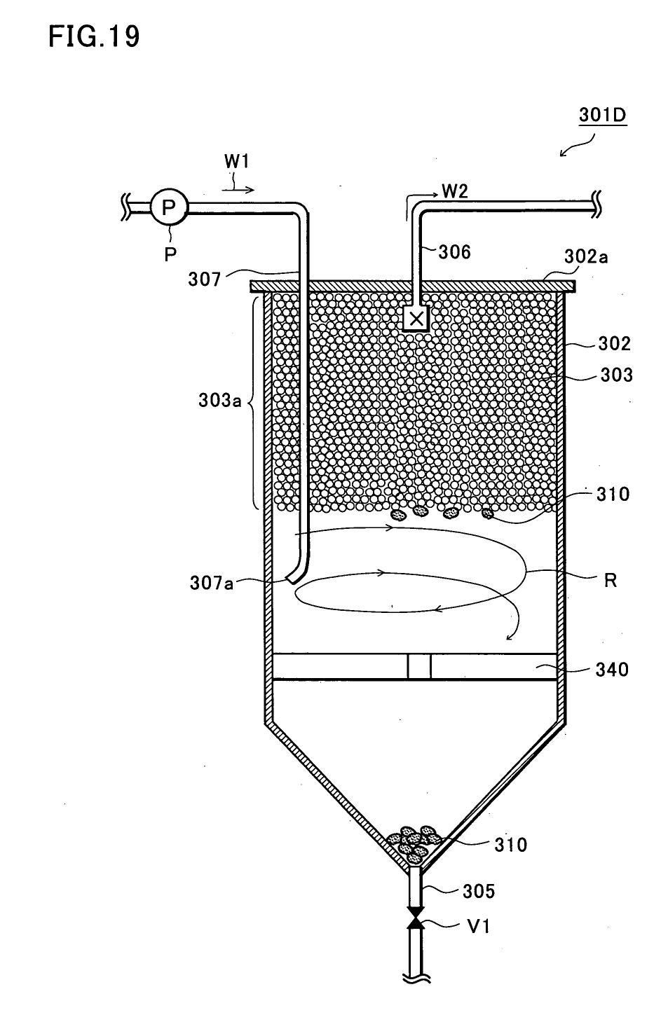

FIG. 19 shows a filtration device (apparatus) 301D using floating filter media according to a thirteenth embodiment of the present invention. With this filtration device 301D, a bottom portion of a filtration section 302 is narrowed down into a funnel shape having a drainage pipe 305 coupled to a lower end thereof. No precipitation chamber 304 is coupled thereto. A cross-shaped separation member 340 as shown in the perspective view of FIG. 4, is arranged inside the filtration section 302.

The configuration of the other elements is as described with reference to the ninth embodiment shown in FIG. 14.

During the filtration process, a rotating/whirling flow R of the treatment wastewater W1 is generated inside the filtration section 302. This flow R is trying to reach a space under the separation member 340 but it crashes into the separation member 340 and therefore is prevented from being transmitted to a lower portion. Accordingly, the flow of the treatment wastewater W1 in the space under the separation member 340 of the filtration section 302 becomes extremely small. Also, contaminants 310 separated by filtration pass the separation member 340 to gravitate downward and contaminants 310 precipitated/deposited at the bottom of the filtration section 302 are prevented from soaring and returning in a space above the separation member 304.

In FIG. 19, the cross-shaped (4-plate shaped) separation member 340 according to the thirteenth embodiment is as that shown in FIG. 4, however, the number of plates may be further increased or decreased. The plates may also be combined in a curbed manner. As separation member, punching metal, oblique plates or a funnel-shaped member can be employed. Moreover, when a plurality of separation members are arranged unevenly in a vertical direction, the shapes of the separation members may be the same or they may very well be different.

In consequence, any member providing communication between a space above (upper space) the position of a separation member and a space below (lower space) that separation member and having the function of preventing a flow R from being transmitted to the lower space can be employed.

Fourteenth Embodiment

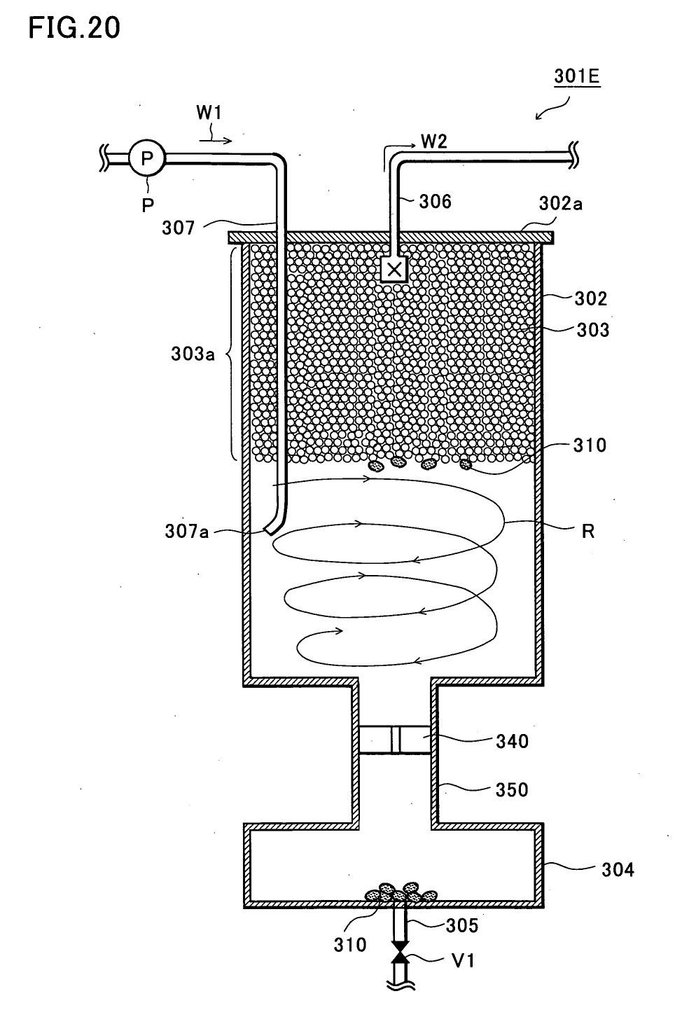

FIG. 20 shows a filtration device (apparatus) 301E using floating filter media according to a fourteenth embodiment of the present invention. With this filtration device 301E, the bottom of a filtration section 302 is coupled to a precipitation section 304 via a coupling tube 350. The sectional area (cross-sectional area) of the coupling tube 350 is smaller than the sectional area (cross-sectional area) of the filtration section 302 and a separation member 340 is arranged inside the coupling tube 350.

The configuration of the other elements is as described with reference to the ninth embodiment shown in FIG. 14.

With this embodiment, a rotating/whirling flow R of the treatment wastewater W1 generated inside the filtration section 302 is restricted to the narrow coupling tube 305 and crashes into the separation member 340. Accordingly, this flow R is prevented from entering the precipitation chamber 304 and the flow of the treatment wastewater W1 inside the precipitation chamber is extremely decreased so that contaminants 310 precipitated/deposited in the precipitation chamber 304 are prevented from soaring and entering inside the filtration section 302.

Fifteenth Embodiment

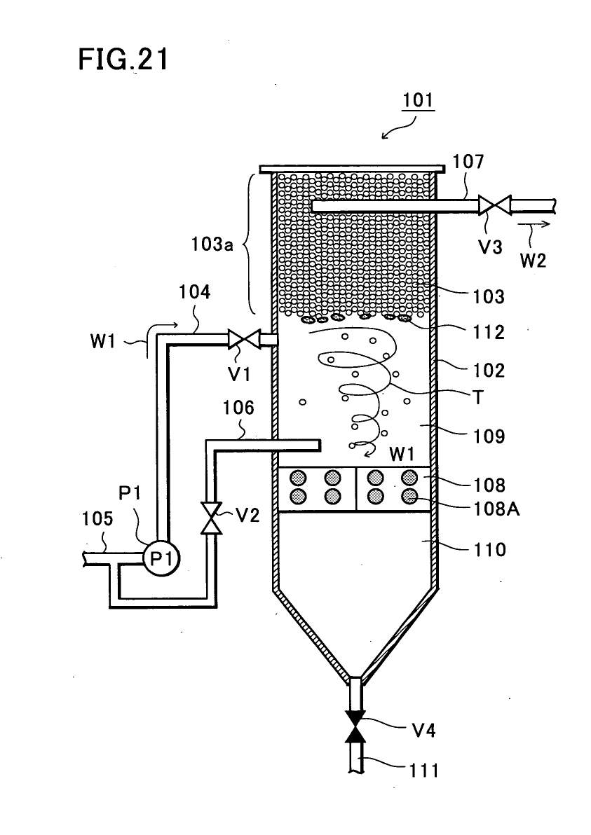

Configuration and operation of a filtration device (apparatus) 101 according to a fifteenth embodiment of this invention are next described with reference to FIG. 21 through 23.

The structure of filtration device according to the present embodiment and illustrated in FIG. 21 is basically similar with that of the filtration device described with reference to FIG. 1, for instance, and the difference therebetween stands in the configuration of the separation member 208. Concretely, openings 108A are provided in the separation member 108 that separates a filtration chamber 109 and a collector 110.

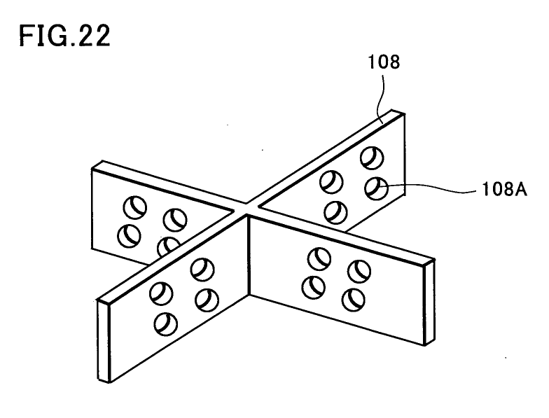

The separation member 108 will now be described in detail with reference to FIG. 22. The separation member 108 is made of two plates combined in a cross shape. The basic shape is as described with reference to FIG. 3. Openings 108A are holes perforated partially in the separation member and in this example, a plurality of such openings 108A having a circular shape are provided, however, other shapes may very well be employed. Concretely, the openings 108A may also have rectangular or triangular, etc. shapes.

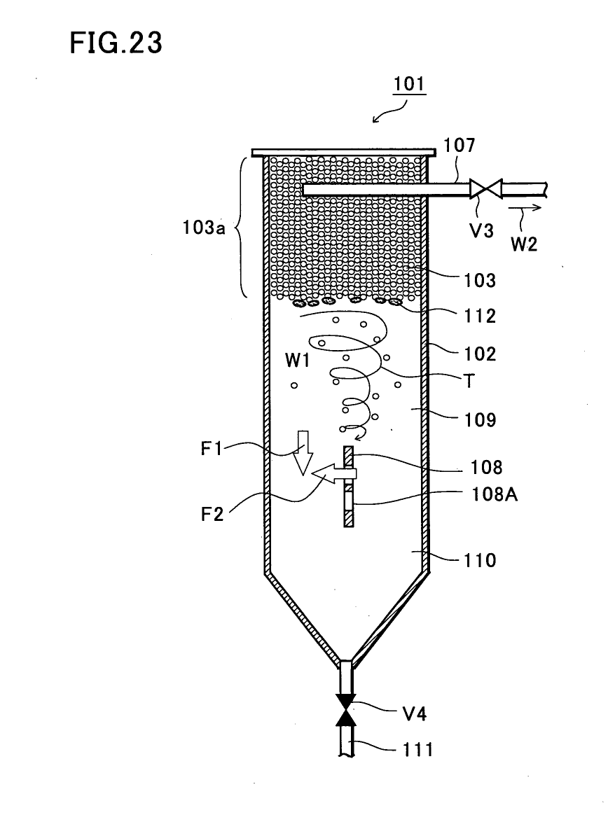

Next, operation of the filtration device 101 will be described with reference to FIG. 23, concentrating mainly on the separation member 108 having the abovementioned structure. A filter layer 103a made of floating filter media, and a filtration chamber 109 where a tornado flow is generated below the filter layer 103a are formed inside the filtration tube 102. Furthermore, a collector 110 is formed below the filtration chamber 109 and a separation member 108 separates the filtration chamber 109 from the collector 110. A tornado flow is generated inside the filtration chamber 109 to prevent clogging of the bottom surface of the filter layer 103a by scraping off filter media 103 and contaminants 112 in the vicinity of the bottom surface of the filter layer 103a. Contaminants 112 are precipitated in the collector 110 which has entered a resting state. The operation of the above-described is same as that described in the first embodiment.

Next, the role played by the separation member 108 during the above-mentioned filtration process will be described. The tornado flow T moves downward while rotating inside the filtration chamber 109. Accordingly, the tornado flow T can be split into a first flow F1 moving in longitudinal direction and a second flow F2 rotating in a lateral direction. In the present embodiment, the first flow F1 and the second flow F2 crash into the openings 108A of the separation member 108 thereby preventing the tornado flow T from entering the collector 110. In other words, the second flow F2 moves partially horizontally from openings 108A provided in the separation member 108. On the other hand, a part of the first flow F1 moves downward following the separation member 108 extending in a longitudinal direction. The second flow F2 that has passed through the openings 108A crashes into the first flow F1 moving in a longitudinal direction. Consequently, the first flow F1 and the second flow F2 neutralize each other and become weaker. As a result, because the tornado flow T does not enter the collector 110, the flow inside the collector is kept in a substantially static state thus preventing contaminants 112 precipitated in the collector 110 from moving upward.

Effects of the Invention

According to this invention and as concretely described in the embodiments, in this filtration device using floating filter media, a spiral flow is generated in the bottom surface of a filter layer formed of floating filter media, thus enabling continuous scraping off of a part of the floating filter media in the outermost surface layer of the filter layer throughout the filtration process. Suppression of filter layer clogging throughout the filtration process enables preservation of filtration properties of the filter layer for a long period of time.

The spiral flow can also be generated by discharging the liquid in a direction following the inner wall of the filtration tube 102. Accordingly, the spiral flow can be generated without the need to provide any fans or additional pumps for spiral flow generation.

Furthermore, treatment wastewater inside a filtration tube can be induced a tornado flow by discharging and rotating/whirling the treatment wastewater supplied from a supply pipe into the filtration tube in a direction following the inner wall of the filtration tube and by sucking the treatment wastewater inside the filtration tube downward by means of a suction pipe. As a result, a new surface having a part of the filter media scraped off and free of any impurities is gradually formed at the bottom surface of the filter layer made of floating filter media thus rendering clogging unlikely to occur and preserving excellent filtration properties over a long period of time.

The filtration tower for filtering and separating impurities from wastewater and the static tower for precipitation of separated impurities form two distinct members which assure an effective filtration process by thus preventing the separated impurities from interfering with the filtration process.

Moreover, the filter media entering the static tower return to the filtration tower via the filter media recovery pipe and discharge of the filter media to the exterior of the filtration device is thereby prevented.

Due to the fact that the wastewater inside the filtration tower flows in a downward direction and the filter media are mixed through a backwash process, impurities adhered to the filter media can be reliably separated at short time intervals thus enabling reliable elimination of filter media clogging at short time intervals.

Furthermore, in the filtration process, filter media existing in the bottom layer of the filter layer are absorbed together with the wastewater and due to the replacement of the bottom layer of the filter layer with filter media exhibiting excellent filtration properties, excellent filtration performance can be preserved over a long period of time.

In this invention, a supply pipe is provided so that it is oriented downwards with respect to a position where a filter layer is formed and even if the filter media fall/gravitate downward when the filtration operation is halted, the filter media are prevented from entering inside the supply pipe. Accordingly, no filter media enter the pump that supplies the treatment wastewater to the supply pipe and clogging and halting of the pump caused by the filter media can be effectively prevented.

With this invention, the treatment wastewater supplied from the supply pipe inside the filtration section is discharged and is caused to rotate/whirl in a direction following the inner wall of the filtration section. As a result, a new surface having a part of the filter media scraped off and free of any impurities is gradually formed at the bottom surface of the filter layer made of floating filter media, thus rendering clogging unlikely to occur and preserving excellent filtration properties over a long period of time.

1. A filtration apparatus comprising:
a filtration container for housing floating filter media forming a stratified filter layer;
a supply pipe for supplying a treatment liquid containing removables to the filtration container;
a discharge pipe for evacuating the treatment liquid which was subject to filtration, wherein
by generating a spiral flow in a lower side of the filter layer, a downward force which is stronger than a buoyant force exerted in the floating filter media is applied to the floating filter media constituting a bottom layer of the filter layer to separate the floating filter media constituting the bottom layer from the filter layer.

2. The filtration apparatus of claim 1, wherein the supply pipe is coupled to the filtration container at a position lower than a bottom surface of the filter layer.

3. The filtration apparatus of claim 1, further comprising at a position lower than the supply pipe, a suction pipe for evacuating the treatment liquid, wherein by suctioning the treatment liquid by the suction pipe, the spiral flow is pulled downwards.

4. The filtration apparatus of claim 3, wherein the treatment liquid suctioned by the suction pipe is returned to the filtration container via the supply pipe.

5. The filtration apparatus of claim 3 wherein a tip of the suction pipe extends until a vicinity of a central section in an inner space of the filtration container.

6. The filtration apparatus of claim 1, wherein the supply pipe is arranged such as to be oriented downwards in a vertical portion where the filter layer is formed and a tip opening of the supply pipe is positioned lower than a bottom surface of the filter layer.

7. The filtration apparatus of claim 1, wherein a specific gravity of the floating filter media is smaller than that of the treatment liquid.

8. The filtration apparatus of claim 1, wherein the supply pipe is coupled tangential to a cross section of the filtration container so that the treatment liquid supplied by the supply pipe is caused to rotate.

9. The filtration apparatus of claim 1, wherein washing of the floating filter media is carried out by causing the treatment liquid to circulate via the suction pipe and the supply pipe while rotating it together with the floating filter media inside the filtration container.

10. The filtration apparatus of claim 3, wherein driving of the suction pipe and supply pipe is carried out by one pump.

11. The filtration apparatus of claim 1, wherein a collector where removables are precipitated and which is separated by a separation member is provided at the bottom of the filtration container.

12. The filtration apparatus of claim 11, wherein the separation member is made of intersecting plates having opening.

13. The filtration apparatus of claim 11, wherein the separation member can be a plates-intersecting structure, oblique plates, a funnel-shaped member or punching metal.

14. The filtration apparatus of claim 3, wherein a first valve, a second valve and a third valve are provided in the supply pipe, suction pipe and discharge pipe, respectively, and a pump is coupled to the supply pipe.

15. The filtration apparatus of claim 14, wherein the treatment liquid is filtered while maintaining the stratified structure of the floating filter media by driving the pump when the first valve, the second valve and the third valve are in an open state.

16. The filtration apparatus of claim 14, wherein the spiral flow sucking in a large part of the floating filter media is generated by driving the pump when the first valve and the second valve are in an open state and the third valve is in a closed state.

17. The filtration apparatus of claim 1, further comprising circulation pipe coupled to the filtration container at a position above the bottom surface of the filter layer, wherein the spiral flow sucking in a large part of the floating filter media is generated by returning the treatment liquid evacuated from the filtration container back inside the filtration container through the circulation pipe.

18. The filtration apparatus of claim 1, further comprising a capture means for capturing the removables and the floating filter media, provided at an entrance of the suction pipe.

19. The filtration apparatus of claim 18, wherein the supply pipe and the suction pipe are connected by a bypass pipe and the removables deposited in the capture means are scraped off by reverse-flowing the treatment liquid in the suction pipe via the bypass pipe.

20. The filtration apparatus of claim 1, further comprising a static tower for collecting the removables, wherein the static tower and the filtration container are connected by a flow pipe, and the static tower and the supply pipe are connected via a filter media recovery pipe.

21. The filtration apparatus of claim 20, wherein the filter media recovery pipe is narrower than the supply pipe.

22. A filtration method for filtering a treatment liquid by passing the treatment liquid containing removables through a filter layer formed of floating filter media, wherein
by generating a spiral flow in a lower side of the filter layer, a downward force which is stronger than a buoyant force exerted in the floating filter media is applied to the floating filter media of a lowermost layer of the filter layer to separate the floating filter media of the lowermost layer from the filter layer.

23. The filtration method of claim 22, wherein a bottom surface of the filter layer is formed in a funnel shape by the spiral flow.

24. The filtration method of claim 22, wherein the spiral flow is generated by introducing the treatment liquid in a direction following an inner wall of a filtration container housing the filter layer.

25. The filtration method of claim 22, wherein the treatment liquid is pulled downward by sucking the treatment liquid to a position below the filter layer.

26. The filtration method of claim 22, wherein particles having a smaller specific gravity than the treatment liquid are used for the floating filter media.

27. The filtration method of claim 22, wherein the filter layer formed of the floating filter media in an upper portion of a filtration container is formed by housing the floating filter media in the filtration container and supplying the treatment liquid into the filtration container.

28. The filtration method of claim 22, wherein simultaneous with the scraping-off of the floating filter media, the removables are also scraped off and the so scraped-off removables are precipitated in a collector at the bottom of the filtration container.

29. The filtration method of claim 28, wherein the collector is separated by a separation member and the water flow is suppressed inside the collector.

30. A filtration method for filtering a treatment liquid by passing the treatment liquid containing removables through a filter layer formed of aggregates of floating filter media, wherein
washing of the floating filter media is carried out by generating, inside a filtration container housing the floating filter media, a spiral flow formed of the treatment liquid and sucking in the floating filter media.

31. The filtration method of claim 30, wherein the spiral flow is generated by introducing the treatment liquid in a direction following an inner wall of the filtration container housing the filter layer.

32. The filtration method of claim 30, wherein particles having a smaller specific gravity than the treatment liquid are used for the floating filter media.

33. The filtration method of claim 30, wherein washing of the floating filter media is carried out while causing the treatment liquid to circulate by retrieving the treatment fluid from below a filter surface of the floating filter media and returning the treatment liquid back inside the filtration container at a position above the filter surface.

34. The filtration method of claim 30, wherein washing of the floating filter media is carried out by rubbing the floating filter media amongst themselves.

35. The filtration method of claim 30, wherein by causing the spiral flow to halt, the washed floating filter media return to a stratified state in an upper side of the filtration container, whereas the removables scraped-off from the floating filter media are precipitated at the bottom side of the filtration container.
